(19) United States
(12) Patent Application Publication
(10) Pub. No.: US 2006/0130706 A1
(43) Pub. Date: Jun. 22, 2006

(54) Dispersible colorant and process for its production, water-based ink making use of the dispersible colorant, ink tank, ink-jet recording apparatus, ink-jet recording process, and ink-jet recorded image

(75) Inventors: Yoshio Nakajima, Yokohama-shi (JP); Masashi Miyagawa, Yokohama-shi (JP); Makoto Aoki, Yokohama-shi (JP); Junichi Sakai, Tokyo (JP); Toshiaki Kaneko, Tokyo (JP); Yoko Ichinose, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/311,944

(22) Filed: Dec. 20, 2005

Related U.S. Application Data
(63) Continuation of application No. PCT/JP05/11874, filed on Jun. 22, 2005.

(30) Foreign Application Priority Data
Jun. 22, 2004 (JP) 2004-184037(PAT.)

(51) Int. Cl. C03C 17/00; C08K 5/00

(52) U.S. Cl. 106/499; 523/160

(57) ABSTRACT

A colorant having self-dispersibility is disclosed. This colorant are composed of colorant particles and flat chargeable resin pseudo fine particles smaller than the colorant particles, and the colorant particles and the flat chargeable resin pseudo fine particles are fused together.

This application is a continuation of International Application No. PCT/JP2005/011874, filed Jun. 22, 2005, which claims the benefit of Japanese Patent Application No. 2004-184037, filed Jun. 22, 2004.

### BACKGROUND OF THE INVENTION

1. Field of the Invention

This invention relates to a dispersible colorant and a process for its production, and further relates to a water-based ink-jet recording ink making use of the dispersible colorant, an ink-jet recording apparatus, an ink-jet recording process, and an ink-jet recorded image.

2. Related Background Art

In general, as performance required in ink-jet recording inks used in ink-jet recording apparatus, it is required that (1) high-resolution, high-density and uniform images free of any blurring or foggingging can be obtained on paper, (2) nozzle tips do not become clogged-because of ink drying to always ensure good ejection response and ejection stability, (3) the ink has good fixing performance on paper, (4) images obtained have good fastness (i.e., rub-off resistance, marker resistance and so forth), and (5) the ink has good long-term storage stability. In particular, as printing speed has become higher in recent years, inks are required to quickly dry and fix and also to give high-image quality print even when images are printed on plain paper such as copying paper.

For such requirements, development is energetically carried out for inks in which colorants substantially insoluble in water, in particular, pigments are used as colorants for water-based ink-jet recording inks which can achieve higher weatherability and water resistance of images.

For example, a water-based pigment ink is disclosed which uses as a colorant a self-dispersion type carbon black in which hydroxyl groups are bonded to particle surfaces of carbon black directly or via other atomic groups (see, e.g., Japanese Patent Application Laid-open No. H10-195360). Such a surface chemically modified pigment is called a self-dispersion type pigment, and does not need any water-soluble resin or the like, resulting in good ink ejection stability. However, according to studies made by the present inventors, there has been such a problem that the colorant weakly adheres to recording paper because the ink contains no resin, and the ink is inferior in rubbing-off resistance and marker resistance on recording paper especially at high print density. Meanwhile, development is carried out for microcapsule type pigments in which pigment particles are coated with a resin (see, e.g., Japanese Patent Application Laid-open No. H8-183920). However, in this case as well, the resin with which the pigment particles are to be coated should have high hydrophilicity in order to achieve a sufficient dispersion stability, and is apt to come off from pigment particle surfaces, thus it is difficult for storage stability to be compatible with dispersion stability. This has come to light as a result of studies made by the present inventors.

Meanwhile, in order to prevent the resin from coming off from pigment particle surfaces, a method making use of aqueous precipitation polymerization is studied as an example of methods by which colorants are modified with a resin having high hydrophobicity. In Japanese Patent Application Laid-open No. 2003-34770, there is disclosed “an aqueous colored fine particle dispersed material containing a water-insoluble colorant, characterized in that the colored fine particle dispersed material is one obtained by dispersing a water-insoluble colorant in an aqueous medium in the presence of a dispersing agent and thereafter adding a vinyl monomer to carry out polymerization, and that the dispersing agent exhibits dispersion stability when the water-insoluble colorant is dispersed and also the latex produced has poor stability when the vinyl monomer is polymerized in the presence of only the dispersing agent”. It is described that where emulsion polymerization is carried out to produce a water-insoluble colorant dispersed material, the dispersing agent is not high in affinity with the vinyl monomer or with the polymer produced, and hence the dispersing agent can not easily be desorbed from the pigment particle surfaces, where the polymerization proceeds on pigment particle surfaces on which the dispersing agent is adsorbed, and hence a fine particle dispersed material whose pigment particle surfaces have been coated can be obtained at a high yield without causing any agglomeration of the fine particles. It is said that by using such a colored fine particle dispersed material, an ink-jet recording ink was obtained which has superior dispersion stability and printing suitability, is free of any paper type dependence, is reduced in metallic luster and is superior in water resistance, light-resistance and rubbing-off resistance.

### SUMMARY OF THE INVENTION

However, as a result of successive studies made by the present inventors on Japanese Patent Application Laid-open No. 2003-34770, no sufficient print density was obtainable especially on plain paper, and a clear difference in print density was seen between glossy paper and plain paper. The reason therefor is considered to be that as set forth in Japanese Patent Application Laid-open No. 2003-34770, the dispersing agent can not easily be desorbed from the pigment particle surfaces, where the polymerization proceeds on pigment particle surfaces on which the dispersing agent is adsorbed, and hence the dispersing agent is adsorbed on the particle surfaces of the aqueous colored fine particle dispersed material obtained, thus the dispersing agent acts as a penetrant especially on plain paper. Accordingly, the present inventors attempted to solve the above problem by purifying and removing the dispersing agent. However, the dispersion stability was greatly lowered, and the attempted solution could not be realized. The reason therefor is considered to be that the fine particle dispersed material in which the pigment particle surfaces have been coated is produced by using a dispersing agent fulfilling the condition that when the vinyl monomer is polymerized in the presence of only the dispersing agent, the latex produced is poor in stability, and hence the polymer with which the pigment particles have been coated can not disperse and stabilize the pigment.

Therefore, in order to obtain a water-based ink which is sufficiently high in dispersion stability, superior in long-term storage stability and superior in adherence on recording mediums, and provides the recorded matter sufficiently high in image density, it is considered that a water-insoluble colorant is required in which colorant particle surfaces are sufficiently stabilized for dispersion while having high functional-group density, a resin component is present on the particle surfaces, and the resin component does not come off from the colorant. However, such a colorant is still unknown in the art.

An object of the present invention is to solve the problems the background art has had, to provide a dispersible colorant in which colorant particle surfaces are sufficiently stabilized for dispersion in an aqueous medium while having high functional-group density, a resin component is present on the particle surfaces and the resin component does not come off from the colorant, and to provide a simple and easy process for its production. A further object of the present invention is to provide a water-based ink-jet recording ink, an ink tank, an ink-jet recording apparatus and an ink-jet recording process which make use of such an excellent dispersible colorant to ensure especially high ink fixing performance thereby forming images superior in rubbing-off resistance, and provide an ink-jet recorded image.

As a result of extensive studies, the present inventors have discovered a novel dispersible colorant that can keep high dispersion stability substantially without requiring any surface-active agent or polymeric dispersing agent and has sufficient adherence to and film-making properties on recording paper, and have found that by the use of such a dispersible colorant, a water-based ink-jet recording ink can be obtained which has sufficient ejection stability and dispersion stability and further gives printings high in image quality and superior in fastness. Thus, they have accomplished the present invention.

More specifically, the present invention is a dispersible colorant which comprises colorant particles and flat chargeable resin pseudo fine particles smaller than the colorant particles wherein the colorant particles and the flat chargeable resin pseudo fine particles are fused together.

The present invention is also a process for producing the dispersible colorant, which comprises the steps of subjecting a radical-polymerizable monomer to aqueous precipitation polymerization in an aqueous dispersion of water-insoluble colorant particles in the presence of an anionic or amphoteric water-soluble radical-polymerization initiator to fuse the colorant particles and the flat chargeable resin pseudo fine particles together.

The present invention is also a process for producing the dispersible colorant, which comprises the step of subjecting a radical-polymerizable monomer to aqueous precipitation polymerization in an aqueous dispersion of water-insoluble colorant particles in the presence of a cationic or amphoteric water-soluble radical-polymerization initiator to fuse the colorant particles and the flat chargeable resin pseudo fine particles together.

The present invention is further a water-based ink in which the above dispersible colorant is contained.

The present invention is still further an ink tank in which the above water-based ink is held.

The present invention is still further an ink-jet recording apparatus in which the above water-based ink is used to form an ink-jet recorded image.

The present invention is still further an ink-jet recording process in which the above water-based ink is used to form an image by means of an ink-jet recording apparatus.

The present invention is still further an ink-jet recorded image formed using the above water-based ink by means of an ink-jet recording apparatus.

The present invention provides a dispersible colorant in which colorant particle surfaces are sufficiently stabilized for dispersion while having high functional-group density, a resin component is present on the particle surfaces and the resin component does not come off from colorant particles, and a simple and easy process for its production. The present invention also provides a water-based ink-jet recording ink, an ink tank, an ink-jet recording apparatus and an ink-jet recording process which make use of such an excellent dispersible colorant to ensure superior fixing performance, and an ink-jet recorded image.

As for another effect of the present invention, an ink is provided which has superior quick-drying performance and rubbing-off resistance on recording mediums. As for still another effect of the present invention, each of a water-based ink having superior glossiness on glossy recording mediums and a water-based ink giving images superior in scratch resistance on glossy recording mediums is provided. As for still another effect of the present invention, a water-based ink superior in long-term storage stability is provided.

### BRIEF DESCRIPTION OF THE DRAWINGS

FIG. 1 is a diagrammatic view showing a basic structure of a dispersible colorant particle on which the flat chargeable resin pseudo fine particles are fused.

FIGS. 2A, 2B, 2C and 2D are diagrammatic views of a typical process in the production process of the present invention.

FIG. 3 is a diagrammatic view showing the course in which the flat chargeable resin pseudo fine particles are purified and fused to a colorant particle in the production process of the present invention.

FIG. 4 is an enlarged diagrammatic view of flat chargeable resin pseudo fine particles in the present invention on the side of their interfaces where they are fused to a colorant particle.

FIG. 5 is an enlarged diagrammatic view of an interface where a flat chargeable resin pseudo fine particle and a colorant particle in the present invention are fused together.

FIGS. 6A and 6B are diagrammatic views of a pigment separation phenomenon occurring where an organic pigment has directly been modified with hydroxyl groups, as typified by what is disclosed in the publication Japanese Patent Application Laid-open No. H10-195360.

### DETAILED DESCRIPTION OF THE PREFERRED EMBODIMENTS

The present invention is described below in a specific manner by giving embodiments of the present invention that are considered to be best. In the first place, the “dispersible colorant” referred to herein means a colorant dispersible in water or in a water-based ink medium substantially without additing any surface-active agent or polymeric dispersing agent, i.e., a colorant having self-dispersibility.

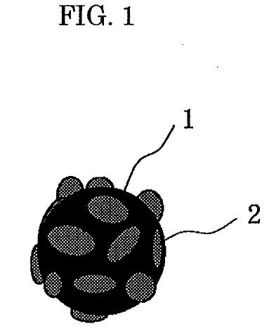

A first characteristic feature of the present invention is in that the colorant is a dispersible colorant comprising colorant particles and flat chargeable resin pseudo fine particles smaller than the colorant particles with the colorant particles being fused to the flat chargeable resin pseudo fine particles. A particle of the dispersible colorant according to the present invention is shown in FIG. 1 as a diagrammatic view. Reference numeral 1 in FIG. 1 is the colorant particle; and 2, the flat chargeable resin pseudo fine particles. A state is diagrammatically shown in which the flat chargeable resin pseudo fine particles 2 are fused to the surface of the colorant particle 1. In the dispersible colorant according to the present invention, colorant particles fuse to the flat chargeable resin pseudo fine particles in this way, whereby colorant particle surfaces are provided with electric charges resulting from the fine particles, so that the dispersible colorant becomes dispersible in water or in a water-based ink medium. Also, at the same time, the dispersible colorant according to the present invention, when applied to a recording medium, exhibits superior adherence in virtue of the presence of the resin component that constitutes the fine particles fused to the colorant particle surfaces. Here, the resin component is not in a simple physical adsorption state, and the flat chargeable resin pseudo fine particles and the colorant particles are in a fusion state, which characterizes the dispersible colorant of the present invention, the flat chargeable resin pseudo fine particles do not come off from the colorant particle surfaces. Hence, the dispersible colorant of the present invention exhibits superior long-term storage stability when formed into a liquid dispersion such as ink.

Here, the flat chargeable resin pseudo fine particles in the present invention refer to resin aggregates in which the resin component is aggregated and preferably which form physical cross-linkages in a large number in their interiors, and further which have a stable form as micro-agglomerates having a flatted spherical form or a shape close thereto. Details on the flat chargeable resin pseudo fine particles are described later.

The fusion state of the colorant particle surfaces and the flat chargeable resin pseudo fine particles as referred to in the present invention is made up by strong mutual action between the colorant particle surfaces and the flat chargeable resin pseudo fine particles. Further, since the fine particles have a flat shape, it follows that such fine particles come into contact with each colorant particle by about 25% or more, and preferably 35% or more, of the specific surface area of each colorant particle. Then, such a fusion state is considered to be achieved by being brought into the following state. Here, the “fusion” in the present invention indicates that the colorant particles and the flat chargeable resin pseudo fine particles are sufficiently and strongly joined, and it is not required that the colorant particles and the flat chargeable resin pseudo fine particles melt into one another at their interfaces.

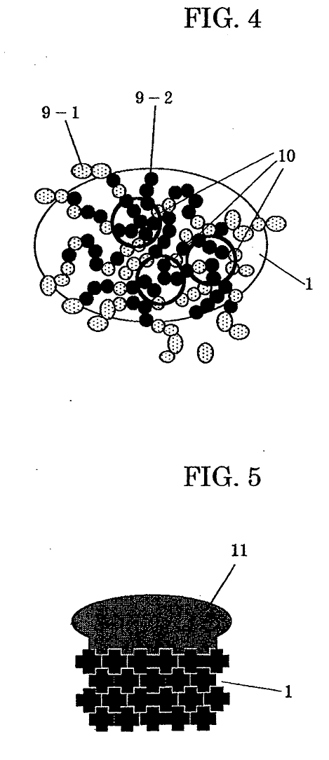

Interfaces between the flat chargeable resin pseudo fine particles and a colorant particle are shown in FIG. 4 as an enlarged diagrammatic view. First, at the interfaces with the colorant particle 1, the flat chargeable resin pseudo fine particles 2 are formed in the state that polymers constituted of various monomer unit compositions are entangled one another (as shown by 9-1 and 9-2 in FIG. 4). Here, the polymers take locally various structures, and a distribution comes about in their surface energy conditions. It follows that the interfaces of the colorant and the polymers are strongly combined at the points where the surface energy of the colorant particle, resulting from its chemical structure and surface structure, and the surface energy of the polymers, resulting from their chemical structure and surface structure, are locally in good agreement with each other. Further, at the interface where one flat chargeable resin pseudo fine particle is joined with the colorant particle, a plurality of points where the surface energies locally consist with each other are present as shown by a reference numeral 10 in FIG. 4. It is supposed that the fusion state in the present invention is established by the strong mutual action at those points.

In particular, in the interiors of the flat chargeable resin pseudo fine particles, strong mutual action is exerted between the polymers, and, in some cases, the polymers are entangled with one another to form physical cross-linkages. Hence, even where the flat chargeable resin pseudo fine particles have many hydrophilic groups, the flat chargeable resin pseudo fine particles standing fused may by no means come off from the colorant particles, or the resin component having hydrophilic groups may by no means continue to melt out of the flat chargeable resin pseudo fine particles. In contrast, in the method of encapsulating colorant particles with a resin as disclosed in Japanese Patent Application Laid-open No. H8-183920, a resin having high hydrophilicity, for example, tends to come off from the colorant particles because such a resin can not be strongly combined with the colorant particles, and as a rusult, the long-term storage stability to be achieved by such encapsulation may not be sufficiently realized.

In the dispersible colorant of the present invention, as an advantage brought about by such a feature that the colorant particles and the flat chargeable resin pseudo fine particles stand are fused together, it may be cited that the dispersible colorant as such can have a larger specific surface area in virtue of the flatted spherical form of the fine particles, so that the electric charges the flat chargeable resin pseudo fine particles have on their surfaces can be distributed over many areas. Thus, inasmuch as the dispersible colorant has a larger specific surface area, the electric charges the flat chargeable resin pseudo fine particles have can serve as surface electric charges of the dispersible colorant at a very high efficiency. More specifically, the form of the dispersible colorant according to the present invention is a form that enables more surface electric charges to be more efficiently arranged on the particle surfaces of the dispersible colorant (see FIG. 4). Compared with the form in which colorants are coated and encapsulated with a resin, as typified by what is disclosed in the publication Japanese Patent Application Laid-open No. H8-183920, even when the substantial acid value or amine value of the resin component is smaller, high dispersion stability can be provided.

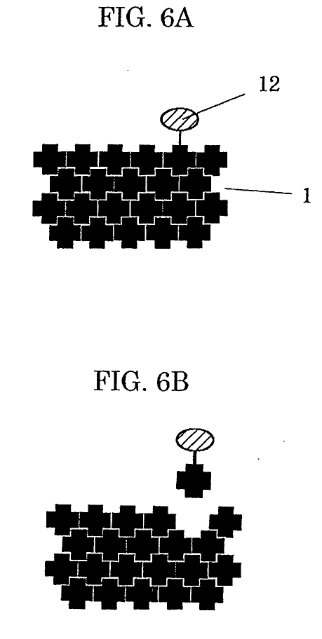

Moreover, in the case where the colorant is an organic pigment, if it is directly chemically modified with a hydrophilic group as in the technique disclosed in the publication Japanese Patent Application Laid-open No. H10-195360, a problem may come about such that what is called “pigment coming-off”, in which pigment molecules originally having come insoluble in water and standing crystallized are made water-soluble by the combination of a hydrophilic group 12 and melt out of pigment particles 1, may take place to cause serious changes in color tones (see FIGS. 6A and 6B). In contrast, in the case of the dispersible colorant according to the present invention in which the colorant is an organic pigment, as described previously a plurality of points where the flat chargeable resin pseudo fine particles act mutually in the state they are fused to the colorant particles are distributed at random. Hence, flat chargeable resin pseudo fine particle 11 becomes fused extending over some pigment molecules in pigment crystals (see FIG. 5). Accordingly, the “pigment coming-off”, occurring in the conventional technique by the fact that the pigment molecules are locally made hydrophilic, is by no means brought about in the present invention. In the present invention, where an organic pigment is used as the colorant, the size of the flat chargeable resin pseudo fine particles is so controlled as to be in the range smaller than the pigment particles and larger than the pigment molecules, whereby an organic pigment dispersible colorant can be obtained which has been provided with high dispersibility without destroying the crystal structure of the pigment.

The feature of the dispersible colorant in which the colorant particles are fused to the flat chargeable resin pseudo fine particles may simply be ascertained by a method which involves three-stage separation as shown below. Initially, in the first separation, the colorant to be ascertained and other water-soluble components (inclusive of a water-soluble resin component) contained in an ink or aqueous dispersion are separated. Next, in the second separation, the colorant and water-insoluble resin components contained in a sediment in the first separation are separated. Further, in the third separation, the resin component weakly adsorbed and the dispersible colorant with the flat chargeable resin pseudo fine particles fused thereto are separated from each other, where the resin component contained in the supernatant liquid in the third separation is quantitatively determined, and the sediment in the second separation is compared with the sediment in the third separation to ascertain the fusion of the colorant particles with the flat chargeable resin pseudo fine particles.

Specifically, the feature may be ascertained under conditions as shown below. The ink or aqueous dispersion in which the colorant is dispersed is taken in an amount of 20 g, and is so adjusted as to be about 10% in total solid-matter weight, where the first separation is carried out by means of a centrifugal separator under conditions of 12,000 rpm and 60 minutes. Of what has been separated, the lower-layer sediment containing the colorant is re-dispersed in approximately a 3-fold amount of pure water, and subsequently the second separation is carried out under conditions of 80,000 rpm and 90 minutes. The lower-layer sediment containing the colorant is re-dispersed in a 3-fold amount of pure water, and subjected to the third separation again under conditions of 80,000 rpm and 90 minutes, and re-dispersed in a 3-fold amount of pure water. The sediment in the second separation and the sediment in the third separation are each so taken as to be in an amount of about 0.5 g in terms of solid matter, and are dried at 30° C. for 18 hours under reduced pressure. The dried sediments obtained are observed on a scanning electron microscope at 50,000 magnifications. As long as it is ascertained that the dispersible colorant observed has a plurality of substances like fine particles or micro-aggregates corresponding thereto, attached to its particle surfaces, and also the respective sediments formed through the second separation and third separation have the same forms, this colorant is judged to be one whose particles are fused with the flat chargeable resin pseudo fine particles. Further, the portion of the upper-layer supernatant liquid in the third separation is gently taken from above by about a half in volume, and the solid-matter weight as solid-matter fraction mass is calculated from changes in mass before and after it is dried at 60° C. for 8 hours. As long as the solid-matter weight is less than 1%, it may be judged that the flat chargeable resin pseudo fine particles have not come off from the dispersible colorant and, in this dispersible colorant, its colorant particles are fused with the flat chargeable resin pseudo fine particles.

The separation conditions described above are preferred examples. Any other separation methods or separation conditions may be used as methods for judging the dispersible colorant according to the present invention as long as they can attain the purposes of the above first separation and second and third separation. More specifically, in the first separation, it is intended to separate the colorant contained in the ink and aqueous dispersion, the resin component adsorbed thereon and the water-soluble components. In the second separation, it is intended to separate the colorant, the resin component standing adsorbed on the colorant particles, and other resin component adsorbed on the colorant particles. Further, in the third separation, it is intended to ascertain that the resin component fused to the colorant particles does not come off. Of course, any other known or newly developed separation methods may also be used as long as they can attend the purposes of the first, second and third separation. As to their procedures as well, more or less than three stages may be used.

A second characteristic feature of the dispersible colorant according to the present invention is in that the dispersible colorant can disperse by itself into an aqueous medium in the state the colorant particle 1 is fused with the flat chargeable resin pseudo fine particles 2 as described above. As mentioned previously, the dispersible colorant according to the present invention is a self-dispersible colorant, which can stably be dispersed in the water or water-based ink substantially without any assistance of other surface-active agents or polymeric dispersing agents. The definition and judgement method therefor are detailed later. Thus, with the dispersible colorant according to the present invention, it is not required to add polymeric dispersing agents, other resin components or surface-active agent components that are likely to be released over a long period of time, for the purpose of stabilizing the dispersion of colorants. As a result, where such a dispersible colorant is used in the water-based ink, the ink can have a large degree of freedom in designing with regard to components other than the dispersible colorant. For example, a water-based ink can be provided which can achieve sufficiently high print density even on recording mediums having high ink permeability, such as plain paper.

The self-dispersibility of the dispersible colorant according to the present invention may be ascertained by, e.g., the following method. First, the ink or aqueous dispersion with the colorant dispersed therein is diluted 10 times with pure water, and then concentrated using an ultrafiltration filter of 50,000 in fractionating molecular weight until reaching the original concentration. The resultant concentrated fluid is separated by means of a centrifugal separator under conditions of 12,000 rpm and 2 hours, and the sediment obtained is taken out and re-dispersed in pure water. Here, when the sediment is desirably re-dispersible, it is judged to have the self-dispersibility. Whether or not it is desirably dispersed may synthetically be judged from whether or not it is uniformly dispersed when observed visually, whether or not any conspicuous sediment forms while the fluid is left standing for 1 to 2 hours, or even if the sediment is formed, whether or not the fluid returns to the original state when shaked lightly, whether or not the average particle diameter is within twice the particle diameters before operation when dispersed-particle diameter is measured by a dynamic light scattering method, and so forth.

As described previously, the dispersible colorant according to the present invention assumes the form in which the colorant particles are fused with the flat chargeable resin pseudo fine particles to have a high specific surface area, and has a large number of electric charges on its large-area surfaces, thereby achieving superior dispersion stability (storage stability) when formed into a liquid dispersion such as the ink. Accordingly, the flat chargeable resin pseudo fine particles can bring further preferable results where they are fused to the colorant particles in a large number and in a dotted state. In particular, it is preferable that the flat chargeable resin pseudo fine particles fused to the colorant particles have a stated distance between the particles, and are preferably uniformly be distributed, and more preferably in such a state that the particle surfaces of the colorant are partly uncovered. Such a state may be ascertained by observing an ink having the dispersible colorant according to the present invention, with a transmission electron microscope or a scanning electron microscope. More specifically, the state is observable in which the flat chargeable resin pseudo fine particles fused to the colorant particle surfaces are fused leaving a stated distance between them or in which the colorant particle surfaces are uncovered between the flat chargeable resin pseudo fine particles fused thereto.

According to studies made by the present inventors, it has come to light that the water-based ink according to the present invention which contains the dispersible colorant described above shows superior quick-drying performance on recording mediums. The reason therefor is not clear, but such superior quick-drying performance is presumed to be based on the following mechanism. As described above, the dispersible colorant is dispersed in the ink in the form in which the flat chargeable resin pseudo fine particles are fused to the colorant particle surfaces. When the ink is brought into contact with the surface of a recording medium, the aqueous solvent in the ink (hereinafter “ink solvent”) is absorbed in pores (which are voids between cellulose fibers in the case of plain paper, and pores of an ink-receiving layer in the case of coated paper or glossy paper) of the recording medium by capillarity. Here, in the dispersible colorant according to the present invention, in virtue of the feature coming from its particle form, the flat chargeable resin pseudo fine particles are dotted at the portions where colorant particles are in contact with one another and hence many fine gaps are formed there, and the capillarity operates on the ink solvent present between the colorant particles. Hence, the ink solvent between the colorant particles is quickly absorbed in the recording medium. Of the dispersible colorants according to the present invention, the one having the form in which the flat chargeable resin pseudo fine particles are dotted on the colorant particle surfaces affords a water-based ink showing more preferable quick-drying performance. From such a fact as well, it is supposed that the quick-drying performance has been achieved by the mechanism described above.

The dispersible colorant according to the present invention may preferably have a surface functional-group density of from 250 μmol/g or more to less than 1,000 μmol/g, and more preferably from 290 μmol/g or more to less than 900 μmol/g. If it has a surface functional-group density which is smaller than this range, the dispersible colorant may have poor long-term storage stability. If on the other hand it has a surface functional-group density which is fairly larger than this range, the dispersible colorant may have so excessively high dispersion stability as to tend to permeate easily into the recording medium when applied to its surface, and hence, when images are formed, it may be difficult to secure a high print density. Meanwhile, where carbon black is used as the colorant, the carbon black has a high specific gravity and its dispersion stability must be increased, and when made into an ink, especially a high black density on the recording medium is preferred. For these reasons, in such a case, the surface functional-group density may more preferably be so set as to be 350 μmol/g or more to less than 800 μmol/g.

In particular, where the surface electric charges of the dispersible colorant are anionic, the surface functional-group density in the present invention may be determined, e.g., in the following way. An aqueous hydrochloric acid solution is added in large excess to an aqueous dispersion, or an ink, containing the dispersible colorant to be measured, followed by sedimentation by means of a centrifugal separator under conditions of 20,000 rpm and 1 hour. The sediment obtained is collected, and then re-dispersed in pure water. Thereafter, the solid-matter fraction is measured by a drying method. The re-dispersed sediment is weighed, and sodium hydrogencarbonate is added thereto in a known quantity, followed by stirring to obtain a fluid dispersion, which is further subjected to sedimentation by means of a centrifugal separator under conditions of 80,000 rpm and 2 hours. The supernatant liquid is weighed, and the known quantity of the sodium hydrogencarbonate is subtracted from the neutralization equivalent determined by neutralization titration with 0.1 N hydrochloric acid. Thus, the surface functional-group density is determined as the number of moles per 1 g of the pigment. Where the dispersible colorant has a cationic group as a polar group, the surface functional-group density may be determined by the same method as the above but using sodium hydroxide in place of the hydrochloric acid and using ammonium chloride in place of the sodium hydrogencarbonate.

Colorant:

The colorant which is a constituent of the dispersible colorant according to the present invention is described below. As colorants in the present invention, any colorants may be used which are conventionally known materials or newly developed ones, and may preferably be insoluble in water and capable of being stably dispersed in water together with a dispersing agent, such as hydrophobic dyes, inorganic pigments, organic pigments, metallic colloids and colored resin particles. Also, colorants are used which may preferably come to have a dispersed-particle diameter within the range of from 0.01 to 0.5 μm (10 to 500 nm), and particularly preferably within the range of from 0.03 to 0.3 μm (30 to 300 nm). The dispersible colorant of the present invention, obtained using the colorant dispersed in such a range can have high coloring power and high weatherability, and hence may preferably be used as the colorant for the water-based ink. In addition, such a dispersed-particle diameter is defined as a cumulative average value of particle diameters measured by a dynamic light scattering method.

Inorganic pigments effectively usable in the present invention may include, e.g., carbon black, titanium oxide, zinc white, zinc oxide, Toripon, cadmium red, iron oxide red, Molybdate Red or chrome vermilion, Molybdate Orange, chrome yellow, cadmium yellow, yellow iron oxide, titanium yellow, chromium oxide, viridian, cobalt green, titanium cobalt green, cobalt chromium green, ultramarine blue, Prussian blue, cobalt blue, cerulean blue, manganese violet, cobalt violet, and mica.

Organic pigments usable in the present invention may include, e.g., various pigments of an azo type, an azomethine type, a polyazo type, a phthalocyanine type, a quinacridone type, an anthraquinone type, an indigo type, a thioindigo type, a quinophthalone type, a bemzimidazolone type, an isoindoline type and an isoindolinone type.

Besides, organic insoluble colorants usable in the present invention may include hydrophobic dyes of an azo type, an anthraquinone type, an indigo type, a phthalocyanine type, a carbonyl type, a quinoneimine type, a methylene type, a quinoline type and a nitro type. Of these, disperse dyes are particularly preferred.

Flat Chargeable Resin Pseudo Fine Particles:

The flat chargeable resin pseudo fine particles (hereinafter “chargeable resin pseudo fine particles”) which are another constituent of the dispersible colorant of the present invention are defined as microbodies which are substantially insoluble in water, are smaller than the colorant particles to which they are to be fused and are composed of aggregates of a resin component having a sufficiently high degree of polymerization. Their forms are apparently flatted spherical. The resin component constituting the chargeable resin pseudo fine particles may preferably be one whose molecular chains are physically or chemically cross-linked with one another. As to whether or not the molecular chains of the resin component constituting the chargeable resin pseudo fine particles are physically or chemically cross-linked with one another, it may be ascertained by, e.g., the following method. The resin component constituting the chargeable resin pseudo fine particles is beforehand estimated by a known analytical method, and a straight-chain type polymer having the same chemical structure (or having the same monomer unit composition) is synthesized by solution polymerization. The chargeable resin pseudo fine particles and the polymer are immersed in an organic solvent which is a good solvent for that polymer, and their solubilities are compared. In this comparison, where the solubility of the chargeable resin pseudo fine particles is lower than the solubility of the polymer, it is ascertained that the interiors of the chargeable resin pseudo fine particles are cross-linked.

As another preferred embodiment, the chargeable resin pseudo fine particles may preferably have, e.g., dispersed-particle diameters in water whose central value is within the range of from 10 to 200 nm when measured by a dynamic light scattering method. Further, from the viewpoint of the long-term storage stability of the dispersible colorant, it is more preferable that the multi-dispersion degree index of the dispersed-particle diameters is kept less than 0.2. If the central value of the dispersed-particle diameters is larger than 200 nm or the multi-dispersion degree index of the dispersed-particle diameters is 0.2 or more, the original aim of finely dispersing and stabilizing the colorant is not sufficiently achievable in some cases. Also, if the central value of the dispersed-particle diameters is smaller than 10 nm, the form as the chargeable resin pseudo fine particles can not sufficiently be maintained to make the resin easily soluble in water, and hence the advantage of the present invention is not obtainable in some cases. On the other hand, the range of from 10 to 200 nm is satisfied and the chargeable resin pseudo fine particles have a particle diameter smaller than the colorant particles, the stabilization of dispersion of the colorant in virtue of its fusion with the chargeable resin pseudo fine particles in the present invention is effectively brought about.

The above preferred embodiment applies alike also in a case in which the dispersed-particle diameters of the chargeable resin pseudo fine particles are not measurable. In such a case, the average diameter of the chargeable resin pseudo fine particles in electron microscopic observation is considered to be in the above preferable range or in the range corresponding thereto.

Where the colorant is an organic pigment, in addition to the above range, the chargeable resin pseudo fine particles are set in such a range that they are smaller than the primary particles of the pigment as described above and larger than the pigment molecules. This is preferable because a dispersible colorant can be obtained which is structurally very stable and has high dispersibility.

Chargeability of the chargeable resin in the present invention refers to a state in which the resin itself holds ionized functional groups in some form and preferably is self-dispersible in virtue of the chargeability. Accordingly, whether or not the resin particles are the chargeable resin pseudo fine particles is ascertained by any method in which the surface zeta potential of the chargeable resin pseudo fine particles is measured by any known method; potential difference titration is carried out by a method described below, to calculate the functional-group density; an electrolyte is added to an aqueous dispersion of the chargeable resin pseudo fine particles to make sure of electrolyte concentration dependence of dispersion stability; or the chemical structure of the chargeable resin pseudo fine particles is analyzed by a known method to examine the presence or absence of ionic surface functional-groups.

The resin component constituting the chargeable resin pseudo fine particles may be any resin component including all sorts of natural or synthetic high polymers commonly used or high polymers newly developed for the present invention, any of which may be used with no limitation. Usable resin components may include, e.g., acrylic resins, styrene-acrylic resins, polyester resins, polyurethane resins, polyurea resins, polysaccharides and polypeptides.

In particular, from the viewpoint of advantages such that the materials are commonly usable and the designing of function of the chargeable resin pseudo fine particles can simply and easily be performed, polymers or copolymers of monomer components having radically polymerizable unsaturated bonds may preferably be used, such as acrylic resins and styrene-acrylic resins.

In producing the chargeable resin pseudo fine particles, it is possible to appropriately control various properties and the like of the dispersible colorant and chargeable resin pseudo fine particles by many control factors such as the type and concentration of a polymerization initiator to be used, the type and copolymerization ratio of constituent monomers, and so forth. In particular, it is preferable that the chargeable resin pseudo fine particles are constituted of, among the foregoing, a copolymer of a monomer component containing at least one hydrophobic monomer, at least one nonionic hydrophilic monomer and at least one anionic or cationic hydrophilic monomer. Here, the chargeable resin pseudo fine particles are constituted using at least one hydrophobic monomer, at least one nonionic hydrophilic monomer, and at least one anionic or cationic hydrophilic monomer, they can be provided with good fusibility to the colorant and thermal stability, the flatted spherical shape and dispersion stability, and the good dispersion stability, respectively. Thus, inasmuch as these monomers are simultaneously used, chargeable resin pseudo fine particles can be obtained which can be always desirably fused to the colorant particles and also can provide good dispersion stability. The above conditions may be fulfilled and the types of monomers and the copolymerization ratio of the resin component constituting the chargeable resin pseudo fine particles may appropriately selected, whereby the dispersible colorant of the present invention and/or the chargeable resin pseudo fine particles to be fused to the colorant particles can be provided with further functional properties.

The hydrophobic monomer used in the present invention may specifically include alkyl acrylicate compounds such as ethyl acrylate and butyl acrylate, and alkyl methacrylicate compounds such as methyl methacrylate, ethyl methacrylate and benzyl methacrylate (hereinafter noted as alkyl (meth)acrylicate compounds, and the like); styrene monomers such as styrene, α-methylstyrene, o-methylstyrene, m-methylstyrene, p-methylstyrene, p-tert-butylstyrene; itaconic esters such as benzyl itaconate; maleic esters such as dimethyl maleate; fumaric esters such as dimethyl fumarate; and acrylonitrile, methacrylonitrile, and vinyl acetate.

In particular, the alkyl (meth)acrylicate compounds have good adherence to the colorant particles, and at the same time have a superior copolymerizability with the hydrophilic monomer described previously, and bring about preferable results from the viewpoint of uniformity of surface properties and uniform fusibility to the colorant particles, of the chargeable resin pseudo fine particles to be formed.

The nonionic hydrophilic monomer used in the present invention may specifically include monomers simultaneously having in the structure a hydroxyl group capable of showing a strong hydrophilicity to the radical-polymerizable unsaturated bond, such as hydroxyethyl (meth)acrylate and hydroxypropyl (meth)acrylate; and further monomers containing an alkylene oxide group, such as methoxypolyethylene glycol (meth)acrylate, ethoxypolyethylene glycol (meth)acrylate, polyethylene glycol (meth)acrylate, and polypropylene glycol (meth)acrylate. Besides, known or novel, various oligomers, macromonomers or the like may also be used without limitations.

In particular, the alkylene oxide group-containing monomers have superior copolymerizability with the hydrophilic monomer described previously, and bring about preferable results from the viewpoint of uniformity of surface properties and uniform fusibility to the colorant particles, of the chargeable resin pseudo fine particles to be formed.

The reason therefor is considered to be as stated below.

Inasmuch as the chargeable resin pseudo fine particles are formed by polymerizing the alkylene oxide group-containing monomer, the monomer is localized on outer surfaces of the fine particles because of its high hydrophilicity, and the copolymer component constituting them comes to have a low glass transition temperature, and hence the fine particles assume the flatted spherical form in the water. As a result, the fine particles each have a large surface area at which they join to the colorant particles, so that the chargeable resin pseudo fine particles assume the form in which the chargeable resin pseudo fine particles are fused firmly to the colorant particles. Then, the dispersible colorant constituted in such a manner makes films on recording paper together with dispersible colorant particles adjacent to one another, in virtue of high film-making properties with which the chargeable resin pseudo fine particles are provided, and can form firm colored films. Accordingly, this dispersible colorant not only can provide print with high rubbing-off resistance, but also enables print superior in rubbing-off resistance to be formed also on glossy recording mediums which are very unfavorable for the rubbing-off resistance.

Moreover, in printing and forming images on recording paper using the water-based ink in an ink-jet recording apparatus, the high fusibility provided to the chargeable resin pseudo particles promotes their fusion with the dispersible colorant particles adjacent to one another, and this can increase a speed of reducing the residual solvent quantity such as water remaining on the recording paper and can shorten the fixing time on the recording paper.

Further, as for the anionic hydrophilic monomer used in the present invention, there are no particular limitations as long as it is a monomer having a functional group showing anionic properties in water. It may include, e.g., monomers having a carboxyl group, such as acrylic acid, methacrylic acid, crotonic acid, ethylacrylic acid, propylacrylic acid, isopropylacrylic acid, itaconic acid and fumaric acid, and salts of these; monomers having a sulfonic acid group, such as styrenesulfonic acid, sulfonic acid-2-propylacrylamide, acrylic acid-2-ethyl sulfonate, methacrylic acid-2-ethyl sulfonate, and butyl acrylamide sulfonic acid, and salts of these; and monomers having a phosphonic acid group, such as methacrylic acid-2-ethyl phosphonate and acrylic acid-2-ethyl phosphonate.

Inasmuch as such constitution containing any of these anionic monomers is employed, more anionic groups can be introduced into the chargeable resin pseudo fine particles, which is effective also as a method of controlling the surface functional-group density of the colorant to the preferable value described previously. Also, inasmuch as such constitution containing any of these anionic monomers is employed, a dispersible colorant can be obtained which exhibits a high dispersion stability especially in a high to medium pH range.

Of the above anionic monomers, acrylic acid, methacrylic acid, p-styrenesulfonic acid and salts of these may particularly preferably be used from the viewpoints of copolymerizability with other monomers, general-purpose properties, strength of anionicity, and so forth.

As for the cationic hydrophilic monomer used in the present invention, there are no particular limitations as long as it is a monomer having a functional group showing cationi properties in water. It may include monomers having a primary amino group, such as aminoethyl acrylate, aminopropyl acrylate, methacrylic acid amide, and aminoethyl methacrylate; monomers having a secondary amino group, such as methylaminoethyl acrylate, ethylaminoethyl acrylate, methylaminoethyl methacrylate, and ethylaminoethyl methacrylate; monomers having a tertiary amino group, such as dimethylaminoethyl acrylate, diethylaminoethyl acrylate, dimethylaminoethyl methacrylate, and diethylaminoethyl methacrylate; monomers having a quaternary amino group, such as dimethylaminoethyl acrylate methyl chloride salt, dimethylaminoethyl methacrylate methyl chloride salt, dimethylaminoethyl acrylate benzyl chloride salt, and diethylaminoethyl methacrylate benzyl chloride salt; and various vinyl imidazoles.

Such constitution containing at least the cationic monomer as the hydrophilic monomer is preferable for obtaining a dispersible colorant exhibiting high dispersion stability especially in a medium to low pH range. Of these, dimethylaminoethyl acrylate and dimethylaminoethyl methacrylate are particularly preferred from the viewpoints of general-purpose properties and copolymerizability with hydrophobic monomers.

It is also a preferred embodiment that a cross-linkable monomer is used. For example, as the cross-linkable monomer, the following may be cited: divinylbenzene, allyl (meth)acrylate, ethylene glycol di(meth)acrylate, diethylene glycol di(meth)acrylate, 1,6-hexane diacrylate, methylenebis(acryl amide), and ethylenebis(acryl amide). Besides, known or novel, various cross-linkable monomers also may be used.

It is still also a preferred embodiment that a chain transfer agent is used to appropriately control the molecular weight of the resin to be obtained. The chain transfer agent used here may include, e.g., mercaptoethyl alcohol, mercaptopropionic acid, and octyl mercaptan.

As described above, the properties of the dispersible colorant of the present invention and/or chargeable resin pseudo fine particles to be fused to the colorant particles can be controlled by appropriately selecting types and copolymerization ratios of monomers constituting the chargeable resin pseudo fine particles. It is also a preferred form that the copolymer component contained in the chargeable resin pseudo fine particles is so controlled as to have a glass transition temperature of from −100° C. or more to 0° C. or less. Inasmuch as it is controlled to have glass transition temperature within this range, the chargeable resin pseudo fine particles fused to the colorant particles can assume the flatted spherical form and also can be fused more firmly to the colorant particles.

The glass transition temperature of the chargeable resin pseudo fine particles may be measured by differential scanning calorimetry commonly used. In the present invention, values measured with DSC822e, manufactured by Mettler-Toledo International Inc., are used. Detailed measuring conditions are described in Examples.

To obtain chargeable resin pseudo fine particles which are preferred in the present invention, it is preferable to select and use, among the above groups of monomers, a monomer which is known to produce a homopolymer having a low glass transition temperature. The hydrophobic monomer may include, for example, a monomer represented by the following formula (1).
CH₂═CH—COOCₙH₍₂ₙ₊₁₎ (n is 3 to 10) (1).

Specifically, the following may be cited: propyl acrylate, isopropyl acrylate, n-butyl acrylate, t-butyl acrylate, isobutyl acrylate, pentyl acrylate, hexyl acrylate, heptyl acrylate, octyl acrylate, nonyl acrylate, decyl acrylate, 2-ethylhexyl acrylate, 2-ethylbutyl acrylate, and dodecyl acrylate.

The hydrophilic monomer may include the above monomers containing an alkylene oxide group.

Synthesis of Chargeable Resin Pseudo Fine Particles and Their Fusion to Colorant Particles:

The synthesis of the chargeable resin pseudo fine particles and the fusion of such particles to the colorant particles may be carried out by a process for synthesizing chargeable resin pseudo fine particles or a process for making a composite of chargeable resin pseudo fine particles and colorant particles, the specific procedure and method for which are known in the art. On the other hand, as a result of extensive studies, the present inventors have invented a simple and easy process for producing the dispersible colorant which is characteristic of the present invention, comprising the colorant particles and the chargeable resin pseudo particles smaller than the colorant particles with the colorant particles and the flat chargeable resin pseudo fine particles fusing to each other. In the following, the process for producing the dispersible colorant of the present invention is described, which is preferably practiced in the present invention.

Studies made by the present inventors have revealed that the dispersible colorant having the properties described above can very simply and easily produced by applying an aqueous precipitation polymerization process under the following conditions. It is a production process by which the chargeable resin pseudo fine particles are fused to the colorant particles through the steps of first dispersing the water-insoluble colorant by the aid of a dispersing agent to make up an aqueous dispersion of the water-insoluble colorant, and then, in this aqueous dispersion, subjecting a radical-polymerizable monomer to aqueous precipitation polymerization in the presence of a water-soluble radical-polymerization initiator. The dispersible colorant obtained through these steps is composed of the water-insoluble colorant the particles of which the chargeable resin pseudo fine particles synthesized through the course of aqueous precipitation polymerization are strongly fused to in a uniform and dotted state, and has superior dispersion stability in itself. In the above process of aqueous precipitation polymerization, the properties of the chargeable resin pseudo fine particles can simply and easily be controlled to have the preferable form having been described above, where the state of fusion to the colorant particles, which is characteristic of the present invention, is favorably achieved. In the following, a preferred embodiment in the above production process is described in detail.

Dispersion of Water-Insoluble Colorant:

First, the colorant used preferably in the present invention as described previously is dispersed by the aid of a dispersing agent to make up an aqueous dispersion. As the dispersing agent for dispersing the colorant in an aqueous solution, any dispersing agent such as an ionic one or a nonionic one may be used. From the viewpoint of keeping the dispersion stability in the subsequent step of polymerization, it is preferable to use a polymeric dispersing agent or a water-soluble polymer. In particular, one having hydrophobic moieties may preferably be used which shows sufficient solubility in water and serves as adsorption sites on the colorant particle surfaces and the oil droplet interfaces of the radical-polymerizable monomer to be added in the polymerization step, in particular, the hydrophobic monomer. More preferably, at least one kind of hydrophobic monomer used in the subsequent step of polymerization may be made to be present as a unit constituting the dispersing agent. This is preferable from the viewpoint of easily inducing the fusion of the chargeable resin pseudo fine particles in the subsequent step of polymerization.

There are no particular limitations on how to produce the polymeric dispersing agent and water-soluble polymer used in the present invention, which function as dispersing agents. For example, a monomer having an ionic group and other polymerizable monomers may be allowed to react in a non-reactive solvent in the presence or absence of a catalyst to produce the polymeric dispersing agent and water-soluble polymer. In particular, it has come to light that when using a dispersing agent selected from i) a styrene/acrylic polymeric compound obtained by polymerizing as essential components the monomer having an ionic group as described previously and a styrene monomer and ii) an ionic group-containing acrylic polymeric compound obtained by polymerizing as essential components the monomer having an ionic group and a (meth)acrylate monomer having 5 or more carbon atoms, good results are brought about. Here, where it is intended that the dispersible colorant to be obtained has especially an anionic group, it is preferable to use an anionic dispersing agent. Where on the other hand it is intended that the dispersible colorant to be obtained has especially a cationic group, it is preferable to use a dispersing agent having a cationic group or a cationic dispersing agent.

In the course of the aqueous precipitation polymerization to be carried out latet, from the viewpoint of promoting the fusion of the chargeable resin pseudo fine particles to the colorant particles and retaining the dispersion stability of the colorant in the course of polymerization, it is also preferable that a dispersing agent having an acid value of from 100 to 250 is used when anionic one is used and a dispersing agent having an amin value of from 150 to 300 is used when cationic one is used. If their acid value and amine value are smaller than these ranges, the affinity of the hydrophobic monomer with the dispersing agent may become higher than the affinity of the colorant with the dispersing agent during the aqueous precipitation polymerization, so that the dispersing agent may come off from the colorant particle surfaces before the chargeable resin pseudo fine particles become fused to the colorant particles, making it impossible to maintain the state of dispersion. Also, if the acid value and amine value are larger than these ranges, the extruded-volume effect and electrostatic repulsion force of the dispersing agent on the colorant particle surfaces may come so strong as to hinder the chargeable resin pseudo fine particles from being fused to the colorant particles. Where the anionic dispersing agent is used, from the viewpoint of not hindering the chargeable resin pseudo fine particles from being fused to the colorant particles, it is preferable to select a dispersing agent having a carboxyl group as the anionic group.

In the course of dispersing the water-insoluble colorant by the aid of the dispersing agent to make up an aqueous dispersion, the colorant may preferably be dispersed to have a dispersed-particle diameter in the range of from 0.01 to 0.5 μm (10 to 500 nm), and particularly preferably in the range of from 0.03 to 0.3 μm (30 to 300 nm). The dispersed-particle diameter in this course is greatly reflected on the dispersed-particle diameter of the dispersible colorant to be obtained, and the above range is preferred from the viewpoint of the coloring power or the weatherability of images and the dispersion stability which have been stated previously.

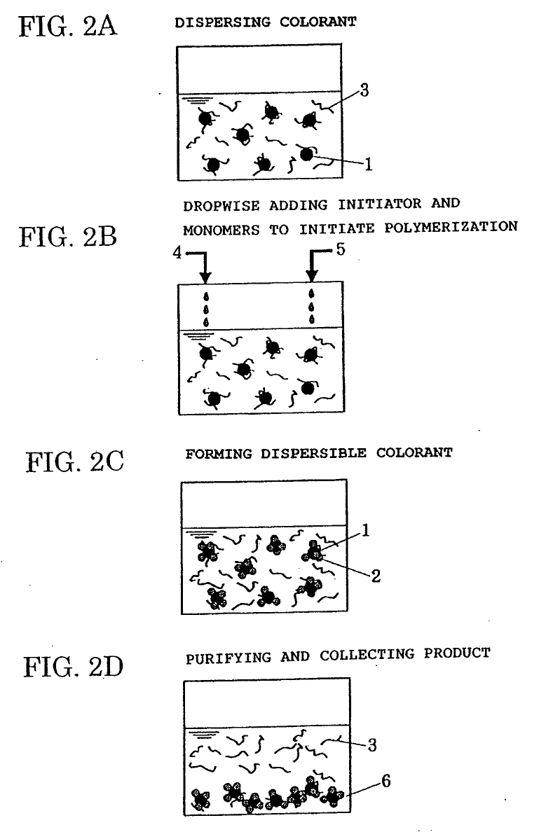

The water-insoluble colorant used in the present invention may preferably be as monodisperse as possible in its dispersed-particle size distribution. In general, the particle size distribution of the dispersible colorant obtained by fusing the chargeable resin pseudo fine particles to the colorant particles tends to be narrower than the particle size distribution in the aqueous dispersion prior to the polymerization step shown in FIG. 2B. It, however, depends basically on the particle size distribution in the aqueous dispersion. Also, it is important that the colorant is made to have a narrow particle size distribution, also in order to surely induce the fusion of the colorant particles with the chargeable resin pseudo fine particles in virtue of hetero-agglomeration. According to studies made by the present inventors, the dispersible colorant obtained can have superior dispersion stability when a colorant having a polydispersity (degree of polydispersion) index of 0.25 or less.

Here, the particle diameter of the dispersed colorant may differ depending on various measuring systems. In particular, it is very rare that organic pigments are spherical particles. In the present invention, the average particle diameter and polydispersity index which are measured with ELS-8000, manufactured by Ohtsuka Denshi Kogyo K.K., on the basis of the principle of dynamic light scattering, and determined by cumulative analysis, are used.

As a method of dispersing the dispersible colorant in an aqueous medium, any conventionally known methods may be used without limitations as long as it is a method making use of a dispersing agent as described previously, among methods by which colorants can stably be dispersed in water. Besides, it may be a dispersion method newly developed for the present invention. As the amount of the polymeric dispersing agent to be added, it may commonly be, e.g., where the dispersible colorant is a pigment, from 10% by weight to 130% by weight based on the weight of the pigment.

This is also preferable in that, where the water-insoluble colorant to be used has no self-dispersibility in itself, it is possible to control the performance of the dispersible colorant obtained according to the preferred embodiment of the chargeable resin pseudo fine particles fused as described previously.

As colorant dispersion methods in the present invention, any methods may be used without limitations as long as they are dispersion methods commonly used for the respective colorants, which make use of dispersion machines such as a paint shaker, a sand mill, an agitator mill and a three-roll mill, or a high-pressure homogenizer such as a microfluidizer, a nanomizer and a multimizer, as well as ultrasonic dispersion machines.

Radical-Polymerization Initiator:

Any radical-polymerization initiators may be used in the present invention as long as it is a commonly available water-soluble radical-polymerization initiator. Specific examples of the water-soluble radical-polymerization initiator may include persulfates. Besides, it may be a redox initiator formed by combining the water-soluble radical-polymerization initiator with a reducing agent. Specifically, it may be used under designing so made as to afford an optimum combination, taking into account of the properties of the colorant, dispersing agent and monomer used in the polymerization, which have previously been described. Preferably, a polymerization initiator may be selected which provides a polymerization initiator residue having the same sign as the surface properties of the dispersible colorant to be obtained. More specifically, where, e.g., a water-insoluble colorant having an anionic group is obtained, an initiator may be selected so that its residual group is neutral or anionic, whereby surface electric charges can more efficiently be obtained. Similarly, where a water-insoluble colorant having a cationic group is obtained, an initiator may preferably be selected so that its residual group is neutral or cationic.

Radical-Polymerizable Monomers:

The radical-polymerizable monomers used in the production process of the present invention serve as components that constitute the chargeable resin pseudo fine particles through the aqueous precipitation polymerization. Hence, as having been described in the section “Flat chargeable resin pseudo fine particles”, the monomers may appropriately be selected in accordance with the properties of the chargeable resin pseudo fine particles and dispersible colorant which are intended to be obtained. Also in the production process of the present invention, any of radical-polymerizable monomers conventionally known in the art and radical-polymerizable monomers newly developed for the present invention may be used.

Aqueous Precipitation Polymerization:

Subsequently, a preferred embodiment of the aqueous precipitation polymerization is described below, which is the step of synthesizing the flat chargeable resin pseudo fine particles characteristic of the production process according to the present invention, and fusing them to the colorant particles. FIGS. 2A to 2C concern a flow sheet diagrammatically illustrating the flow of steps in the above production process. The course taken until the dispersible colorant is obtained through the present steps is considered as described below. First, as shown in FIG. 2A, an aqueous dispersion is prepared in which colorant particles 1 have been dispersed by the aid of a dispersing agent 3. Here, the colorant is stabilized for dispersion in virtue of the adsorption of the dispersing agent, and this adsorption is in a thermal equilibrium state. Next, the aqueous dispersion prepared in the step shown in FIG. 2A is heated with stirring, and a monomer component 4 is added together with a water-soluble radical-polymerization initiator 5 (see FIG. 2B). The water-soluble radical-polymerization initiator thus added is cleaved by heating to generate radicals, and contributes to the reaction of the hydrophobic monomer dissolved in the aqueous phase in a trace quantity and the water-soluble monomer in the aqueous phase, among the monomer components added to the aqueous dispersion.

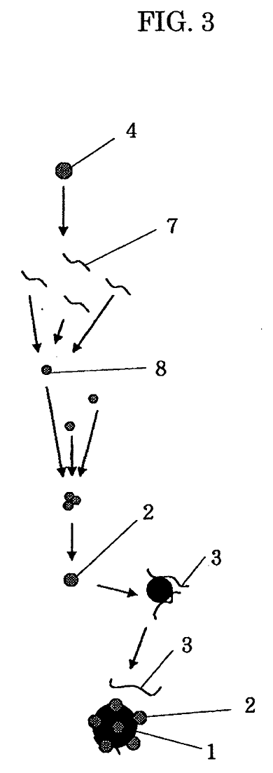

FIG. 3 is a diagrammatic view illustrating the course in which a monomer 4 polymerizes until the dispersible colorant is formed. As the reaction of the monomer 4 as described above proceeds, oligomers 7 formed as a result of the reaction of polymerization of the monomer component turns insoluble in water to become precipitated (8). However, the oligomers having precipitated here do not have sufficient dispersion stability, and hence coalesce to form chargeable resin pseudo fine particles 2. The chargeable resin pseudo fine particles 2 further cause hetero-agglomeration on hydrophobic particle surfaces the colorant in the aqueous dispersion has, which serve as nuclei, so that the resin component constituting the chargeable resin pseudo fine particles 2 are strongly adsorbed to the colorant particle surfaces in virtue of their hydrophobic mutual action. Here, the polymerization reaction continues to proceed in the interiors of the chargeable resin pseudo particles 2, where the chargeable resin pseudo fine particles change into a form that becomes more stable in energy while increasing the sites of adsorption to the colorant particles. Simultaneously, physical cross-linkages are highly formed in the interiors of the chargeable resin pseudo fine particles, and hence the chargeable resin pseudo fine particles is fixed in the form in which they are most stably adsorbed to the colorant particles, to come into a fused state. Meanwhile, each colorant particle 1 is stabilized as a plurality of chargeable resin pseudo fine particles become fused thereto, and the dispersing agent 3 having been in a equilibrium state come off from the colorant particle surfaces.

The chargeable resin pseudo fine particles on the side of their interfaces where they are fused to a colorant particle are shown in FIG. 4 as a diagrammatic view. In the chargeable resin pseudo fine particles which are aggregates of the resin component, hydrophilic monomer units 9-1, hydrophobic monomer units 9-2 and so forth are present in arbitrary distribution. Hence, their local surface energies are distributed, and adsorption sites 10 where such surface energies correspond with the surface energy of the colorant particle are present innumerably. An interface where a chargeable resin pseudo fine particle and a colorant particle are fused together is shown in FIG. 5 as an enlarged diagrammatic view. The chargeable resin pseudo fine particle is adsorbed at its interface 11, the adsorption site 10 shown in FIG. 4, and fused stably in the form corresponding to the surface shape of the colorant particle 1. As stated above, in this course as well, the polymerization reaction continues to proceed in the interiors of the chargeable resin pseudo fine particles, and hence their fusion to the colorant particles is achieved due to their fixation in the form in which the adsorption is stabilized. Through the course as described above, the dispersible colorant constituted as described previously is formed with ease (see FIG. 2C). Here, in the system where the chargeable resin pseudo fine particles have sufficient surface electric charges to achieve the self-dispersibility, the electrostatic repulsion force acts mutually between the chargeable resin pseudo fine particles in the course of their adsorption and fusion to the colorant particles in virtue of hetero-agglomeration, whereby the chargeable resin pseudo fine particles are fused to the colorant particles in a dotted state to have such a preferable form as described previously.

Conditions for the polymerization reaction may differ depending on the properties of the polymerization initiators, dispersing agents and monomers to be used. For example, the reaction temperature may be set at 100° C. or less, and preferably in the range of from 40 to 80° C. Also, the reaction time may be 1 hour or more, and preferably from 6 hours to 30 hours. The stirring speed during the reaction may be set at 50 to 500 rpm, and preferably from 150 to 400 rpm.

In the polymerization step described previously, especially when the monomer component containing at least one hydrophobic monomer, at least one nonionic hydrophilic monomer and at least one anionic or cationic hydrophilic monomer is polymerized to produce the chargeable resin pseudo fine particles, it is preferable to add the monomer component dropwise to the aqueous dispersion of the water-insoluble colorant, containing the water-soluble radical-polymerization initiator. In order to obtain the desired chargeable resin pseudo fine particles uniformly from the mixture of the monomers having different properties as in the hydrophobic monomer and the hydrophilic monomers, it is preferable to keep always constant the polymerization ratio of the monomers having different properties. Where the mixture of monomers is added to the polymerization system in excess as compared with the quantity of, monomers to be consumed in the polymerization reaction in a certain time, there is a tendency for only a particular kind of monomer to be precedently polymerized, and for remaining monomers to be polymerized after the monomer to be precedently polymerized is consumed. In such a case, the chargeable resin pseudo fine particles formed may be greatly uneven in their properties. On the other hand, by adding the monomer component dropwise to the aqueous dispersion of the water-insoluble colorant, containing the water-soluble radical-polymerization initiator, the chargeable resin pseudo fine particles can uniformly be obtained in which the polymerization ratio of the hydrophobic monomer to the hydrophilic monomers is kept always constant and which are constituted in the desired polymerization ratio.

When, in particular, the anionic monomer such as acrylic resin or methacrylic resin is added as a hydrophilic monomer to the polymerization system, the system is rendered partly unstable depending on the properties of the polymeric dispersing agent with which the colorant is dispersed, resulting in agglomeration. In order to prevent this, the anionic monomer may be neutralized in advance and added in the state of a sodium salt or a potassium salt, which is also a preferred embodiment.

In preparing a water-based ink by using the water-insoluble colorant fused with the flat chargeable resin pseudo fine particles according to the present invention, obtained in the steps described above, it is preferable to further carry out purification treatment in addition to the above steps. In particular, in order to maintain the high storage stability the dispersible colorant has, it is important to carry out purification treatment for the unreacted polymerization initiator, monomer component and dispersing agent, the water-soluble resin component not fused to the colorant particles, and the flat chargeable resin pseudo fine particles. As for a purification method used here, the best method may be selected from purification methods which are in common use. For example, the purification carried out using centrifugation or ultrafiltration is a preferred embodiment.

Through the polymerization steps described above, the dispersible colorant in which the desired flat chargeable resin pseudo fine particles composed of the desired copolymer are fused to the particle surfaces of the colorant can be obtained by controlling many control factors. In particular, where the anionic monomer is used aiming at high dispersion stability, the dispersible colorant produced through the above polymerization steps can be obtained as one having a high surface functional-group density, even if the anionic monomer used in the above steps is in a relatively small quantity, and hence the colorant can be provided with high dispersion stability. As a result, the chargeable resin pseudo fine particles make it possible to enhance the dispersion stability of the dispersible colorant without impairing its long-term storage stability. The reason therefor is not clear, and is presumed as below. When the polymerization is initiated by the radicals generated in water and the oligomers become precipitated to form the chargeable resin pseudo fine particles, portions having many components derived from the anionic monomer are preferentially oriented on the aqueous-phase side, i.e., in the vicinity of the surfaces of the chargeable resin pseudo fine particles. This state is maintained also after the chargeable resin pseudo fine particles are fused to the colorant particles, and it follows that many anionic groups derived from the anionic monomer are further present on the particle surfaces of the dispersible colorant of the present invention, structurally having a large specific surface area. As a result, the dispersible colorant obtained by the production process of the present invention is expected to be formed as one furhter stabilized using less anionic monomer.

Water-Based Ink:

The water-based ink of the present invention is characterized by containing the dispersible colorant described above. In the case where the colorant is a pigment, the pigment may commonly be so used as to be in a content of from 0.1 to 20% by weight, and preferably from 0.3 to 15% by weight, based on the weight of the ink. Further, the ink may preferably contain water as an aqueous medium, or further optionally contain a water-soluble organic solvent. It may also contain a penetrant for assisting ink penetration to recording mediums, an antiseptic, a mildew-proofing agent and so forth.

The dispersible colorant of the present invention is present in the ink in the state as shown in FIG. 1 that the chargeable resin pseudo fine particles 2 are fused to the surface of the colorant particle 1. Hence, colorant particles mutually adhere to recording paper and colorant particles adjacent to one another on the recording paper, via the chargeable resin pseudo fine particles fused to the colorant particles. Thus, the print obtained using the water-based ink of the present invention containing such a colorant can have superior rubbing-off resistance. Further, inasmuch as such chargeable resin pseudo fine particles have a flatted spherical form, the distance between the colorant particles adjacent to one another can be short when the colorant particles adhere to one another, and the speed of agglomeration of the colorant particles can be increased. Hence, the speed of ink fixing on the recording paper can be increased. Also, good bleeding performance is exhibited. Further, when printed on a glossy medium on which it is usually difficult to obtain glossy images using a water-insoluble colorant, inasmuch as the chargeable resin pseudo particles fused to the colorant particles have a flatted spherical form, the colorant particles adhered to the medium can form a smooth surface, and hence irregular reflection can be prevented to enable high-gloss printing to be made.

Recorded Image:

The ink-jet recorded image of the present invention is formed using the water-based ink of the present invention, on a recording medium by means of an ink-jet recording apparatus described later. As the recording medium used in the present invention, any recording medium may be used without limitations as long as ink-jet recording can be performed thereon.

Image Recording Process and Recording Apparatus:

The dispersible colorant of the present invention and the water-based ink using same are used in a head of an ink ejection system, and is useful for an ink tank holding the ink therein or as an ink with which the ink tank is to be filled. In particular, the present invention brings about excellent effects in a recording head and a recording apparatus which are of an ink-jet recording system, in particular, a bubble-jet system.

As for their typical construction and principles, a system is preferred which performs recording by the use of basic principles disclosed in, e.g., U.S. Pat. No. 4,723,129 and U.S. Pat. No. 4,740,796. This system is applicable to any of what are called an on-demand type and a continuous type. In particular, in the case of the on-demand type, this system is effective because at least one drive signal corresponding to recording information and giving rapid temperature rise that exceeds nucleate boiling is applied to an electricity-heat converter disposed corresponding to a sheet or liquid channel where the ink is held, to generate heat energy in the electricity-heat converter to cause film boiling on the heat-acting face of a recording head, and consequently bubbles in ink can be formed in one-to-one correspondence to this drive signal. The growth and shrinkage of the bubbles eject the ink through ejecting openings to form at least one droplet. Where this drive signal is applied in a pulse form, the growth and shrinkage of the bubbles take place instantly and appropriately, and hence the ejection of ink in an especially good response can be achieved, which is more preferred. This drive signal in a pulse form is preferred which are disclosed in U.S. Pat. No. 4,463,359 and U.S. Pat. No. 4,345,262. In addition, when employing conditions disclosed in U.S. Pat. No. 4,313,124, which relates to the rate of temperature rise on the heat-acting face, more superior recording can be performed.

As for the construction of the recording head, the present invention is useful also for the construction made up by combining an ejection orifice, a liquid channel and an electricity-heat converter as disclosed in each of the above U.S. Patents (a linear liquid channel or a right-angle liquid channel), and besides for the constitution in which a heat-acting part is disposed in a bent region, as disclosed in U.S. Pat. No. 4,558,333 and U.S. Pat. No. 4,459,600. In addition, the present invention is effective also for the construction in which an ejection orifice common to a plurality of electricity-heat converters is provided as an ejection part of the electricity-heat converters (see Japanese Patent Application Laid-open No. S59-123670, etc.).

Further, a recording head of a full-line type, having a length corresponding to the width of a maximum recording medium on which a recording apparatus can perform recording, may have any of the construction in which the length condition is fulfilled by combining a plurality of recording heads as disclosed in the above publication and the construction composed of one recording head which is integrally formed, where the present invention can more effectively bring about the above effect.

In addition, the present invention is useful also for a case of using an exchangeable chip type recording head which can make an electrical connection with the apparatus main body or feed ink from the apparatus main body, or a cartridge type recording head installed integrally in the recording head itself. Also, a restoration means, a preliminary auxiliary means and so forth may be provided as the construction of the recording apparatus to which the present invention is applied. This is preferable because the effect of the present invention can be more stably exhibited. Specific examples of these are a capping means, a cleaning means and a pressure or suction means which are provided for the recording head; an electricity-heat converter or a heating means different therefrom, or a preliminary heating means composed of a combination of these; and a preliminary ejection mode which effects ejection different from recording.

### EXAMPLES

The present invention is described below in greater detail by giving Examples and Comparative Examples. The scope of the present invention is by no means limited by the following Examples. In the following, “part(s)” and “%” are by weight unless particularly noted.

### Example 1

Recording Ink 1 according to Example 1 was prepared in the following procedure. First, an aqueous mixture of 10 parts of carbon black, 6 parts of glycerol, 10 parts of a styrene-acrylic acid type resin dispersing agent and 74 part of water was subjected to dispersion for 5 hours at 1,500 rpm by means of a sand mill manufactured by Kaneda Scientific Co., Ltd., to prepare Pigment Dispersion 1. In the sand mill, zirconia beads of 0.6 mm in diameter were used, and the packing in the pot was 70%. The carbon black used in this Example was BLACK PEARLS 880 (hereinafter simply “BP880”), commercially available from Cabot Corp in U.S.A. Also, as the styrene-acrylic acid type resin dispersing agent, one was used having a copolymerization ratio of 70:30, an MW of 8,000 and an acid value of 170. Such a styrene-acrylic acid type resin dispersing agent was one obtained beforehand as an aqueous solution by adding water, and potassium hydroxide in an amount equivalent to the above acid value, followed by stirring at 80° C. Pigment Dispersion 1 obtained were stably dispersed in an average dispersed-particle diameter of 98 nm and had a polydispersity index of 0.16.

Next, the above Pigment Dispersion 1 was used in an amount of 100 parts, and, in an atmosphere of nitrogen, the following three liquids each infused into a 50 ml syringe were slowly dropwise added using a microfeeder (manufactured by Furue Science Co., Ltd.) over 5 hours to carry out polymerization in the state the system was heated to 70° C. and with stirring by means of a motor, followed by aging for 2 hours. The liquids added were formulated to have (1) 4.0 parts of butyl acrylate and 1.5 parts of M230G (trade name; available from Shin-Nakamura Chemical Co., Ltd.; methoxypolyethylene glycol monomethacrylate; molecular weight: about 1,100), (2) 0.5 part of acrylic acid, 0.35 part of potassium hydroxide and 4.5 parts of water and (3) 0.05 part of potassium persulfate and 20 parts of water. The dispersion obtained was diluted 10 times with water, and then centrifuged for 10 minutes at 5,000 rpm to remove agglomerated components, and thereafter, further centrifuged under conditions of 12,500 rpm and 2 hours to yield a sediment Dispersible Colorant 1.

This Dispersible Colorant 1 was dispersed in water and centrifuged for 60 minutes at 12,000 rpm to re-disperse the sediment in water. What was thus re-dispersed was dried, and observed on a scanning electron microscope JSM-6700 (manufactured by JOEL High-Tech Ltd.) at 50,000 magnifications. As a result, in the above Dispersible Colorant 1, a state was observed in which flat chargeable resin pseudo fine particles smaller than the particles of the colorant carbon black were fused to the particle surfaces of carbon black. Also in respect of colorants following the colorant presented in this Example, their forms were ascertained by the same method.

Next, Dispersible Colorant 1 obtained was so mixed with the following components as to be in a concentration of 4% in ink, followed by pressure filtration with a membrane filter of 2.5 microns in pore size to make up Recording Ink 1 of this Example. In addition, the total weight of the ink was so adjusted as to be 100 parts, using water. The same applies also to inks following the ink in this Example.

| | |
|---|---|
| Glycerol | 7 parts |
| Diethylene glycerol | 5 parts |
| Trimethylol propane | 7 parts |
| ACETYLENOL EH | 0.2 part |
| (trade name; available from | |
| Kawaken Fine Chemicals | |
| Co., Ltd.) | |
| Ion-exchanged water | balance |

### Example 2

100 parts of the same Pigment Dispersion 1 as prepared in Example 1 was used, and the following three liquids were slowly dropwise added thereto over 5 hours in the same manner as in Example 1 to carry out polymerization, followed by aging for further 2 hours. The liquids added were formulated to have (1) 2.8 parts of benzyl methacrylate and 2.5 parts of M90G (trade name; available from Shin-Nakamura Chemical Co., Ltd.; methoxypolyethylene glycol monomethacrylate; molecular weight: about 500), and 0.2 part of divinylbenzene, (2) 0.5 part of acrylic acid, 0.35 part of potassium hydroxide and 4.5 parts of water and (3) 0.05 part of potassium persulfate and 20 parts of water. After the polymerization, the product was centrifuged in the same manner as in Example 1 to effect purification, obtaining Dispersible Colorant 2. The dispersible colorant thus obtained was observed in the same manner as in Example 1. As a result, it was observed that flat chargeable resin pseudo fine particles smaller than the colorant particles were fused to the colorant particles. Next, preparation was carried out in the same manner as in Example 1 so that Dispersible Colorant 2 obtained was in a concentration of 4%, obtaining Recording Ink 2 in this Example.

### Example 3

100 parts of the same Pigment Dispersion 1 as prepared in Example 1 was used, and the following three liquids were slowly dropwise added thereto over 5 hours in the same manner as in Example 1 to carry out polymerization, followed by aging for 2 hours. The liquids added were formulated to have (1) 2.7 parts of methyl methacrylate, 2.7 parts of M90G and 0.1 part of 1,6-hexane diacrylate, (2) 0.5 part of acrylic acid, 0.35 part of potassium hydroxide and 4.5 parts of water and (3) 0.05 part of potassium persulfate and 20 parts of water. After the polymerization, the product was centrifuged in the same manner as in Example 1 to effect purification, obtaining Dispersible Colorant 3. The dispersible colorant thus obtained was observed in the same manner as in Example 1. As a result, it was observed that flat chargeable resin pseudo fine particles smaller than the colorant particles were fused to the colorant particles. Next, preparation was carried out in the same manner as in Example 1 so that Dispersible Colorant 3 obtained was in a concentration of 4%, obtaining Recording Ink 3 of this Example.

### Example 4

100 parts of the same Pigment Dispersion 1 as prepared in Example 1 was used, and the following three liquids were slowly dropwise added thereto over 5 hours in the same manner as in Example 1 to carry out polymerization, followed by aging for 2 hours. The liquids added were formulated to have (1) 11.7 parts of butyl acrylate, 4.5 parts of M230G and 0.3 part of divinylbenzene, (2) 1.5 parts of acrylic acid, 1.05 parts of potassium hydroxide and 13.5 parts of water and (3) 0.15 part of potassium persulfate and 20 parts of water. After the polymerization, the product was centrifuged in the same manner as in Example 1 to effect purification, obtaining Dispersible Colorant 4. The dispersible colorant thus obtained was observed in the same manner as in Example 1. As a result, it was observed that flat chargeable resin pseudo fine particles smaller than the colorant particles were fused to the colorant particles. Next, preparation was carried out in the same manner as in Example 1 so that Dispersible Colorant 4 obtained was in a concentration of 4%, obtaining Recording Ink 4 of this Example.

### Example 5

100 parts of the same Pigment Dispersion 1 as prepared in Example 1 was used, and the following three liquids were slowly dropwise added thereto over hours in the same manner as in Example 1 to carry out polymerization, followed by aging for further 2 hours. The liquids added were formulated to have (1) 3.8 parts of butyl acrylate, 1.5 parts of M230G and 0.2 part of 1,6-hexane diacrylate, (2) 0.5 part of sodium p-styrene sulfonate and 5.5 parts of water and (3) 0.05 part of potassium persulfate and 20 parts of water. After the polymerization, the product was centrifuged in the same manner as in Example 1 to effect purification, obtaining Dispersible Colorant 5. The dispersible colorant thus obtained was observed in the same manner as in Example 1. As a result, it was observed that flat chargeable resin pseudo fine particles smaller than the colorant particles were fused to the colorant particles. Next, preparation was carried out in the same manner as in Example 1 so that Dispersible Colorant 5 obtained was in a concentration of 4%, obtaining Recording Ink 5 of this Example.

### Example 6

Recording Ink 6 according to this Example was produced in the following procedure. First, an aqueous mixture of 10 parts of carbon black, 6 parts of glycerol, 10 parts of a styrene-dimethylaminoethyl acrylate copolymer cationic resin dispersing agent and 74 part of water was subjected to dispersion for 5 hours at 1,500 rpm by means of a sand mill manufactured by Kaneda Scientific Co., Ltd., to prepare Pigment Dispersion 2. In the sand mill, zirconia beads of 0.6 mm in diameter were used, and the packing in the pot was 70%. The carbon black was the same BP880 as used in Example 1. Also, as the styrene-dimethylaminoethyl acrylate copolymer cationic resin dispersing agent, one was used having a copolymerization ratio of 70:30, an MW of 8,000 and an amine value of 170. The resin dispersing agent used was one obtained beforehand as an aqueous solution by adding water, and acetic acid in a somewhat excessive amount in comparison with the amine value, followed by stirring at 80° C. Pigment Dispersion 2 obtained was stably dispersed in an average dispersed-particle diameter of 105 nm and had a polydispersity index of 0.18.

Next, 100 parts of the above Pigment Dispersion 6 was used, and the following two liquids were slowly dropwise added thereto over 5 hours with stirring by means of a motor, followed by aging for 2 hours. The liquids added were formulated to have (1) 2.0 parts of methyl methacrylate, 1.2 parts of dimethylaminoethyl acrylate and 2.8 parts of M90G and (2) 0.3 part of potassium persulfate, sodium thiosulfate equimolar to the potassium persulfate and 20 parts of water. After the polymerization, the dispersion obtained was diluted 10 times with water, and then centrifuged for 10 minutes at 5,000 rpm to remove agglomerated components, and thereafter, further centrifuged under conditions of 12,500 rpm and 2 hours to yield a sediment Dispersible Colorant 6.

The dispersible colorant thus obtained was observed in the same manner as in Example 1. As a result, it was observed that flat chargeable resin pseudo fine particles smaller than the colorant particles were fused to the colorant particles. Next, using Dispersible Colorant 6 obtained, preparation was carried out in the same formulation as in Example 1, followed by filtration to make up Recording Ink 5 in this Example.

### Example 7

Recording Ink 7 according to this Example was produced in the following procedure. First, an aqueous mixture of 10 parts of Pigment Blue (PB) 15:3 (available from Clariant(Japan) K.K.) as a colorant, 6 parts of glycerol, 10 parts of a styrene-acrylic type dispersing agent and 74 parts of water was subjected to dispersion for 5 hours at 1,500 rpm by means of a sand mill manufactured by Kaneda Scientific Co., Ltd., to prepare Pigment Dispersion 3. In the sand mill, zirconia beads of 0.6 mm in diameter were used, and the packing in the pot was 70%. As the styrene-acrylic resin used as a dispersing agent, one was used having a copolymerization ratio of 70:30, an MW of 8,000 and an acid value of 170. Pigment Dispersion 3 obtained was stably dispersed in an average dispersed-particle diameter of 108 nm and had a polydispersity index of 0.14.

Next, 100 parts of the above Pigment Dispersion 3 was used, and the following three liquids were slowly dropwise added thereto over 5 hours in the same manner as in Example 1 to carry out polymerization, followed by aging for 2 hours. The liquids added were formulated to have (1) 4.0 parts of butyl acrylate and 1.5 parts of M90G, (2) 0.5 part of acrylic acid, 0.35 part of potassium hydroxide and 4.5 parts of water and (3) 0.05 part of potassium persulfate and 20 parts of water. After the polymerization, the dispersion obtained was diluted 10 times with water, and then centrifuged for 10 minutes at 5,000 rpm to remove agglomerated components, and thereafter, centrifuged under conditions of 12,500 rpm and 2 hours to yield a sediment Dispersible Colorant 7.

The dispersible colorant thus obtained was observed in the same manner as in Example 1. As a result, it was observed that flat chargeable resin pseudo fine particles smaller than the colorant particles were fused to the colorant particles. Next, using Dispersible Colorant 7 obtained, preparation was carried out in the same formulation as in Example 1, so as to be in a pigment concentration of 3.5%, followed by filtration to make up Recording Ink 7 of this Example.

### Example 8

To obtain Recording Ink 8 of this Example, a pigment dispersion was prepared in the same procedure as in Example 7 except that 10 parts of Pigment Red 122 (available from Clariant(Japan) K.K.) was used as the colorant, to prepare Pigment Dispersion 4. Pigment Dispersion 4 prepared was satbly dispersed in an average dispersed-particle diameter of 99 nm and had a polydispersity index of 0.12.

Next, 100 parts of the above Pigment Dispersion 4 was used, and the following three liquids were slowly dropwise added thereto over 5 hours in the same manner as in Example 1 to carry out polymerization, followed by aging for 2 hours. The liquids added were formulated to have (1) 4.0 parts of butyl acrylate and 1.5 parts of M90G, (2) 0.5 part of acrylic acid, 0.35 part of potassium hydroxide and 4.5 parts of water and (3) 0.05 part of VA057 (available from Wako Pure Chemical Industries, Ltd.; product name: 2,2-azobis[2-{N-(2-carboxyethyl)amidino}propane] and 20 parts of water. After the polymerization, the dispersion obtained was diluted 10 times with water, and then centrifuged for 10 minutes at 5,000 rpm to remove agglomerated components, and thereafter, further centrifuged under conditions of 12,500 rpm and 2 hours to yield a sediment Dispersible Colorant 9.

The dispersible colorant thus obtained was observed in the same manner as in Example 1. As a result, it was observed that flat chargeable resin pseudo fine particles smaller than the colorant particles were fused to the colorant particles. Next, using Dispersible Colorant 8 obtained, preparation was carried out in the same formulation as in Example 1, so as to be in a pigment concentration of 4.0%, followed by filtration to make up Recording Ink 8 of this Example.

### Example 9

To obtain Recording Ink 9 of this Example, a pigment dispersion was prepared in the same procedure as in Example 7 except that 10 parts of Pigment Yellow (PY) 74 (available from Clariant(Japan) K.K.) was used as the colorant, to prepare Pigment Dispersion 5. Pigment Dispersion 5 obtained was stably dispersed in an average dispersed-particle diameter of 112 nm and had a polydispersity index of 0.16.

Next, 100 parts of the above Pigment Dispersion 4 was used, and the following three liquids were slowly dropwise added thereto over 5 hours in the same manner as in Example 1 to carry out polymerization, followed by aging for 2 hours. The liquids added were formulated to have (1) 4.0 parts of butyl acrylate and 1.5 parts of M90G, (2) 0.5 part of acrylic acid, 0.35 part of potassium hydroxide and 4.5 parts of water and (3) 0.05 part of potassium persulfate and 20 parts of water. After the polymerization carried out over 5 hours as described above, the dispersion obtained was diluted 10 times with water, and then centrifuged for 10 minutes at 5,000 rpm to remove agglomerated components, and thereafter, further centrifuged under conditions of 12,500 rpm and 2 hours to yield a sediment Dispersible Colorant 9.

The dispersible colorant thus obtained was observed in the same manner as in Example 1. As a result, flat chargeable resin pseudo fine particles fused to the colorant particles were observed. Next, using Dispersible Colorant 9 obtained, preparation was carried out in the same formulation as in Example 1, so as to be in a pigment concentration of 4.0%, followed by filtration to make up Recording Ink 9 of this Example.

Properties of Dispersible Colorant:

The respective dispersible colorants obtained in Examples 1 to 9 were observed and their various physical properties were measured. The results obtained were as shown together in Tables 1-1 and 1-2.

Observation Results and Dotted Feature:

Each dispersible colorant was dispersed in water and then dried, and was observed on a scanning electron microscope JSM-6700 (manufactured by JOEL High-Tech Ltd.) at 50,000 magnifications. Then, cases where it was confirmed, and not confirmed, that the flat chargeable resin pseudo fine particles were fused were evaluated respectively as “Y” (yes) and “N” (no), to show evaluation results of the observation. Also, in this observation, a case where it was confirmed that the fine resin particles were dotted was evaluated as “Y”; and a case where they were seen to be localized or fused unevenly, as “N”, to evaluate their dotted feature.

Dispersion Stability:

An aqueous 5% dispersion of each dispersible colorant was diluted 10 times, and then concentrated using an ultrafiltration filter of 50,000 in fractionating molecular weight until reaching the original concentration. The concentrated dispersion was separated by means of a centrifugal separator under conditions of 12,000 rpm and 2 hours. The sediment formed by separation was taken out and re-dispersed in pure water, to make sure whether or not the dispersible colorant was dispersed uniformly when observed visually and whether or not the average particle diameter as measured by the dynamic light scattering method was within twice the particle diameters before operation. Cases where the dispersible colorant fulfilled, and did not fulfilled, such conditions were indicated respectively by “Y” and “N”, to evaluate the self-dispersibility.

Average Dispersed-Particle Diameter:

Each dispersible colorant was measured with ELS-8000, manufactured by Ohtsuka Denshi Kogyo K.K., by the dynamic light scattering method, and the cumulative average value obtained was regarded as the average particle diameter.

Glass Transition Temperature, Tg (° C.):

The glass transition temperature of the fine resin particles fused to the colorant particles of each dispersible colorant were measured with DSC822e, manufactured by Mettler-Toledo International Inc., using as a sample each dispersible colorant having been dried.

Surface Functional-Group Density:

The surface functional-group density of each dispersible colorant was determined in the following way. An aqueous hydrochloric acid solution was added in large excess to an aqueous dispersion of the dispersible colorant, followed by sedimentation by means of a centrifugal separator under conditions of 20,000 rpm and 1 hour. The sediment-obtained was re-dispersed in pure water. Then, the solid-matter fraction was determined and the sediment was weighed, and sodium hydrogencarbonate was added thereto in a known quantity, followed by stirring to prepare a fluid dispersion, and was subjected to sedimentation by means of a centrifugal separator under conditions of 80,000 rpm and 2 hours. The supernatant liquid was weighed, and the known quantity of the sodium hydrogencarbonate was subtracted from the neutralization equivalent determined by neutralization titration with 0.1 N hydrochloric acid to calculate the surface functional-group density. Where it was apparent that the dispersible colorant had a cationic group as a polar group, the surface functional-group density was determined by the same method but using sodium hydroxide in place of the hydrochloric acid and using ammonium chloride in place of the sodium hydrogencarbonate.

Long-Term Storage Stability:

As to the storage stability, an ink prepared using each dispersible colorant in a pigment concentration of 10% was placed into a sample bottle made of glass, and in that state, was left standing for a month at room temperature, and the state of dispersion in the ink was judged by visual observation. Evaluation criteria are as shown below.

A: Neither agglomeration nor settling of the solid matter is seen.

B: Settling of the solid matter is somewhat seen, but the ink returns to the original uniform state of dispersion when shaked lightly.

C: Agglomeration and settling of the solid matter are seen, and the ink does not become uniform even when shaked lightly.

TABLE 1-1
Chief Composition of Dispersible Colorants
1 to 5 and Resultant Properties

| | Dispersible Colorant | | | | |
|---|---|---|---|---|---|
| | 1 | 2 | 3 | 4 | 5 |
| Colorant: | BP880 | BP880 | BP880 | BP880 | BP880 |
| Acid value of | 170 | 170 | 170 | 170 | 170 |
| dispersing agent: | | | | | |
| Raw-material | nBA | BzMA | MMA | nBA | nBA |
| monomers: | M230G | M90G | M90G | M230G | M230G |
| | AAc | AAc | AAc | AAc | NaSS |
| | | DVB | 1,6HDDA | DVB | 1,6HDDA |
| Ratios of | 4.0 | 2.8 | 2.7 | 11.7 | 3.8 |
| monomers charged: | 1.5 | 2.5 | 2.7 | 4.5 | 1.5 |
| | 0.5 | 0.5 | 0.5 | 1.5 | 0.5 |
| | | 0.2 | 0.1 | 0.3 | 0.2 |
| Total monomer | 6 | 6 | 6 | 18 | 6 |
| weight: | | | | | |
| Initiator: | KPS | KPS | KPS | KPS | KPS |
| Observation results: | Y | Y | Y | Y | Y |
| Dottedness: | Y | Y | Y | Y | Y |
| Dispersion stability: | Y | Y | Y | Y | Y |
| Average dispersed- | 118 | 129 | 125 | 120 | 111 |
| particle diameter: | | | | | |
| (nm) | | | | | |
| Tg: (° C.) | −55 | −25 | −30 | −59 | −51 |
| Surface functional- | 355 | 359 | 372 | 351 | 352 |
| group density: | | | | | |
| (μmol/g) | | | | | |
| Long-term storage | A | A | A | A | A |
| stability: | | | | | |

nBA: n-Buthyl acrylate,
MMA: Methyl methacrylate,
BzMA: Benzyl methacrylate,
M230G: trade name; available from Shin-Nakamura Chemical Co., Ltd.; methoxypolyethylene glycol monomethacrylate (molecular weight: about 1,100),
M90G: trade name; available from Shin-Nakamura Chemical Co., Ltd.; methoxypolyethylene glycol monomethacrylate (molecular weight: about 500),
AAc: Acrylic acid,
NaSS: Sodium p-styerene sulfonate,
DMAEA: Dimethylaminoethyl acrylate,
DVB: Divinylbenzene,
1,6HDDA: 1,6-hexane diacrylate,
KPS: Potassium persulfate,
NaTS: Sodium thiosulfate,
VA057: trade name; available from Wako Pure Chemical Industries, Ltd.; 2,2-azobis[2-{N-(2-carboxyethyl)amidino}propane].

TABLE 1-2
Chief Composition of Dispersible Colorants
6 to 9 and Resultant Properties

| | Dispersible Colorant | | | |
|---|---|---|---|---|
| | 6 | 7 | 8 | 9 |
| Colorant: | BP880 | PB15:3 | PR122 | PY74 |
| Acid value of dispersing | (170)* | 170 | 170 | 170 |
| agent: | | | | |
| Raw-material monomers: | MMA | nBAA | nBA | nBA |
| | M90G | M90G | M90G | M90G |
| | DMAEA | AAc | AAc | AAc |
| Ratios of monomers charged: | 2.0 | 4.0 | 4.0 | 4.0 |
| | 2.8 | 1.5 | 1.5 | 1.5 |
| | 1.2 | 0.5 | 0.5 | 0.5 |
| Total monomer weight: | 6 | 6 | 6 | 6 |
| Initiator: | KPS/NaTS | KPS | VA-057 | KPS |
| Observation results: | Y | Y | Y | Y |
| Dottedness: | Y | Y | Y | Y |
| Dispersion stability: | Y | Y | Y | Y |
| Average dispersed-particle | 138 | 123 | 104 | 145 |
| diameter: (nm) | | | | |
| Tg: (° C.) | −29 | −53 | −54 | −50 |
| Surface functional-group | 368 | 265 | 270 | 268 |
| density: (μmol/g) | | | | |
| Long-term storage stability: | A | A | A | A |

*Cationic, as amine value.

Evaluation Method and Evaluation Results of Water-Based Ink-Jet Recording Ink:

Using each recording ink obtained by the method described above, images were printed on recording mediums by using an ink-jet recording apparatus, and images obtained were evaluated. As the ink-jet recording apparatus, an ink-jet printer BJS700, manufactured by CANON INC, was used to form images. Here, a black ink was infused into a BCI-3eBk tank, and cyan, magenta and yellow inks were infused into ink tanks for corresponding colors, and the tanks were set in the printer. Then, the image density (OD), sharpness, rubbing-off resistance and marker resistance of the print obtained by printing under the above conditions and the long-term storage stability at normal temperature and ejection stability of the inks were evaluated in the following way. Results obtained are shown in Tables 2-1 and 2-2.

Image Density (OD):

Using each recording ink, a Bk text was printed on CANON PPC paper, and thereafter the image density (OD) of print after a lapse of a day was measured. A case in which the OD of the print was 1.3 or more was evaluated as “A”, a case in which the OD was from 0.8 or more to less than 1.3 as “B”, and a case in which the OD was less than 0.8 as “C”. However, in regard to Example 7, a cyan text was printed in place of the Bk text, the optical density of cyan images in place of black images was measured. A case in which the OD was 1.0 or more was evaluated as “A”. Similarly, in regard to Example 8 and Example 9, the optical density of magenta images and yellow images were measured and evaluated, respectively.

Fixability:

As to the fixability of print, print areas were rubbed one time at 20 seconds after printing was finished, with Silbon paper to which a load of 40 g/cm² was applied. Any disruption of the print areas was visually observed and evaluated according to the following criteria.

A: No stain at white background areas is seen.

B: White background areas stain slightly, but no problem on the legibility of characters or letters.

C: Diruption of print comes about, and white background areas stain apparently.

Rubbing-Off Resistance:

As to the rubbing-off resistance of print, print areas were rubbed five times with Silbon paper to which a load of 40 g/cm² was applied. Any disorder of the print areas was visually observed to make evaluation according to the following criteria.

A: Neither disruption of print as a result of the rubbing nor stain at white background areas is seen.

B: Disruption of print as a result of the rubbing and stain at white background areas are hardly seen, and are not unpleasant.

C: Print is greatly disrupted as a result of the rubbing, and white background areas are seen to have stained.

Long-Term Storage Stability:

As to the storage stability, each ink was placed into a sample bottle made of glass, and in that state, was left standing for a month at room temperature, and the state of dispersion in the ink was judged by visual observation. Evaluation criteria are as shown below.

A: Neither agglomeration nor settling of the solid matter is seen.

B: Settling of the solid matter is somewhat seen, but the ink returns to the original uniform state of dispersion when shaked lightly.

C: Agglomeration and settling of the solid matter are seen, and the ink does not become uniform even when shaked lightly.

Ejection Stability:

As to the ejection stability, a specific Bk text was continuously printed on 100 sheets, and the print at the initial stage was compared with the last print and judged by visual inspection.

A: Neither lines nor non-uniformity is seen, and there is no difference between the initial stage and the last.

B: Slight lines, non-uniformity and twist are seen, but images are printable without any problem.

C: Great lowering in grade is seen, or images become unprintable.

TABLE 2-1
Physical Properties of Recording Inks 1 to 5 and
Results of Print Evaluation

| | Recording Ink | | | | |
|---|---|---|---|---|---|
| | 1 | 2 | 3 | 4 | 5 |
| Dispersible colorant: | 1 | 2 | 3 | 4 | 5 |
| Raw-material | nBA | BzMA | MMA | nBA | nBA |
| monomers: | M230G | M90G | M90G | M230G | M230G |
| | AAc | AAc | AAc | AAc | NaSS |
| | | DVB | 1,6HDDA | DVB | 1,6HDDA |
| Dotted feature: | Y | Y | Y | Y | Y |
| Tg: (° C.) | −55 | −25 | −30 | −59 | −51 |
| Image density (OD): | A | A | A | A | A |
| Fixability: | A | A | A | A | A |
| Rubbing-off | A | A | A | A | A |
| resistance: | | | | | |
| Long-term storage | A | A | A | A | A |
| stability: | | | | | |
| Ejection stability: | A | A | A | A | A |

TABLE 2-2
Physical Properties of Recording Inks 6 to 9 and
Results of Print Evaluation

| | Recording Ink | | | |
|---|---|---|---|---|
| | 6 | 7 | 8 | 9 |
| Dispersible colorant: | 6 | 7 | 8 | 9 |
| Raw-material monomers: | MMA | nBA | nBA | nBA |
| | M90G | M90G | M90G | M90G |
| | DMAEA | AAc | AAc | AAc |
| Dotted feature: | Y | Y | Y | Y |
| Tg (° C.) | −29 | −53 | −54 | −50 |
| Image density (OD): | A | A | A | A |
| Fixability: | A | A | A | A |
| Rubbing-off resistance: | A | A | A | A |
| Long-term storage stability: | A | A | A | A |
| Ejection stability: | B | A | A | A |

As shown in the above, in all Examples, it has been ascertained that good observation results are obtained in respect of the dispersible colorants obtained and that colorants having self-dispersibility are obtained. In addition, it has been ascertained that all the recording using these colorants exhibit excellent print performance.

### Comparative Example 1

Pigment Dispersion 1 before the step of polymerization, prepared in Example 1, was so prepared in the same formulation as to be in a pigment concentration of 4%, and used as Comparative Ink 1. The colorant in Comparative Ink 1 was observed in the same manner as in Example 1. As a result, any fine resin particles fused to the colorant particle surfaces were not seen.

### Comparative Example 2

First, an aqueous 2% solution of the styrene-acrylic acid type resin dispersing agent used in Example 1 and potassium hydroxide equivalent thereto was used in an amount of 100 parts, and in an atmosphere of nitrogen, the following liquid was slowly dropwise added thereto to carry out polymerization for 5 hours in the state the system was heated to 70° C. and with stirring by means of a motor. The liquid added was formulated to have 5.5 parts of methyl methacrylate, 0.5 part of acrylic acid, 0.35 part of potassium hydroxide, 0.05 part of potassium persulfate and 20 parts of water. The dispersion obtained was diluted 10 times with water, and then centrifuged for 10 minutes at 5,000 rpm to remove agglomerated components, and thereafter, centrifuged under conditions of 20,000 rpm and 1 hour to yield a sediment Fine Resin Particles B-1.

Next, Pigment Dispersion 1 before the step of polymerization, prepared in Example 1, and Fine Resin Particles B-1 obtained as described above were adjusted in the same formulation as in Example 1 so that the former was in a solid-matter concentration of 4% and the latter was in a concentration of 1.6%, to prepare Comparative Ink 2. The colorant in Comparative Ink 2 was observed in the same manner as in Example 1. As a result, on the colorant particle surfaces, fused fine resin particles were seen in places, but unevenly distributed, and agglomerates of the fine resin particles were seen.

Comparative Inks Obtained in the Above

Comparative Examples 1 and 2 were evaluated in the same manner as done in Example 1. Results obtained are shown in Table 4.

TABLE 4
Physical Properties of Comparative Inks 1 and 2 and
Results of Print Evaluation

| | Comparative Ink 1 | Comparative Ink 2 |
|---|---|---|
| Colorant: | Comparative Ex. 1 | Comparative Ex. 2 |
| Observation results: | N | N |
| Dottedness: | — | — |
| Resin fine particles: | — | MMA |
| | | AAc |
| Tg: (° C.) | — | 105 |
| Image density (OD): | C | C |
| Fixability: | B | C |
| Rub-off resistance: | C | C |
| Long-term storage stability: | C | C |
| Ejection stability: | C | C |

As shown in the above, in both Comparative Examples 1 and 2, the inks were greatly inferior to Examples especially in respect of the print density, the long-term storage stability and the ejection stability. Also, in Comparative Example 2, since the fine resin particles were not suitably fused, the ink was greatly inferior also in respect of the rubbing-off resistance and fixability of images.

Evaluation on Glossy Medium:

In regard to the recording inks obtained in Examples 1 to 5, evaluation was further made on glossy mediums. More specifically, using the printer used in a series of the evaluations described above, Bk solid patches of 5 cm square each were printed on ink-jet recording glossy paper PR-10, commercially available from CANON INC., and image density, rubbing-off resistance and glossiness on glossy paper were evaluated. The results obtained are shown in Table 5.

Glossy Paper Image Density:

After the printing, the image density (OD) of print after a lapse of a day was measured. A case in which the OD of the print was 2.3 or more was evaluated as “A”, a case in which the OD was from 1.7 or more to less than 2.3 as “B”, and a case in which the OD was less than 1.7 as “C”.

Glossy Paper Rubbing-Off Resistance:

As to the rubbing-off resistance of print, print areas were rubbed five times with Silbon paper to which a load of 40 g/cm² was applied. Any scrape in image areas was visually observed and evaluated according to the following criteria.

A: Scrapes of images or stains at white background areas are hardly seen.

B: Scrapes of images are seen, but 90% or more of print areas remain.

C: Images are greatly scraped.

Glossiness:

The glossiness at print areas was visually evaluated according to the following criteria.

A: Print areas have glossiness hardly different from white background areas.

B: Print areas reflect light more irregularly than white background areas, but have sufficient glossiness.

C: Print areas have no glossiness, and hardly reflect light.

TABLE 5
Physical Properties of Inks of Examples 1 to 5 and
Results of Print Evaluation

| | Example | | | | |
|---|---|---|---|---|---|
| | 1 | 2 | 3 | 4 | 5 |
| Dispersible colorant: | 1 | 2 | 3 | 4 | 5 |
| Material monomers: | nBA | BzMA | MMA | nBA | nBA |
| | M230G | M90G | M90G | M230G | M230G |
| | AAc | AAc | AAc | AAc | NaSS |
| | | | 1.6HDDA | | |
| Dotted feature: | Y | Y | Y | Y | Y |
| Tg: (° C.) | −55 | −25 | −30 | −59 | −51 |
| Glossy paper image | A | B | B | A | B |
| density: | | | | | |
| Glossy paper | B | B | A | A | B |
| rubbing-off resistance: | | | | | |
| Glossiness: | A | B | A | A | A |

This application claims a priority from Japanese Patent Application No. 2004-184037 filed on Jun. 22, 2004, the contents of which are incorporated herein by reference.

What is claimed is:

1. A dispersible colorant comprising colorant and flat chargeable resin pseudo fine particles smaller than the colorant, wherein the colorant and the flat chargeable resin pseudo fine particles are fused together.

2. The dispersible colorant according to claim 1, wherein said flat chargeable resin pseudo fine particles are fused to said colorant particles in a dotted state.

3. The dispersible colorant according to claim 1, which has a surface functional-group density of from 250 μmol/g or more to less than 1,000 μmol/g.

4. The dispersible colorant according to claim 1, wherein said flat chargeable resin pseudo fine particles comprises a copolymer composed of a monomer component containing at least one hydrophobic monomer, at least one nonionic hydrophilic monomer and at least one anionic hydrophilic monomer.

5. The dispersible colorant according to claim 4, wherein said nonionic hydrophilic monomer comprises a nonionic hydrophilic monomer having at least an alkylene oxide group.

6. The dispersible colorant material according to claim 4, wherein the copolymer constituting said flat chargeable resin pseudo fine particles has a glass transition temperature of from −100° C. or more to 0° C. or less.

7. The dispersible colorant material according to claim 4, wherein said hydrophobic monomer contains at least an acrylate compound represented by the following structural formula (1):
CH₂═CH—COOCₙH₍₂ₙ₊₁₎ (n is 3 to 10) (1).

8. A process for producing the dispersible colorant according to claim 1, which comprises the step of subjecting a radical-polymerizable monomer to aqueous precipitation polymerization in an aqueous dispersion of water-insoluble colorant in the presence of an anionic or amphoteric water-soluble radical-polymerization initiator to fuse the colorant and the flat chargeable resin pseudo fine particles together.

9. The dispersible colorant according to claim 1, wherein said flat chargeable resin pseudo fine particles comprises a copolymer composed of a monomer component containing at least one hydrophobic monomer, at least one nonionic hydrophilic monomer and at least one cationic hydrophilic monomer.

10. The dispersible colorant according to claim 9, wherein said nonionic hydrophilic monomer comprises a nonionic hydrophilic monomer having at least an alkylene oxide group.

11. The dispersible colorant according to claim 9, wherein the copolymer constituting said flat chargeable resin pseudo fine particles has a glass transition temperature of from −100° C. or more to 0° C. or less.

12. The dispersible colorant according to claim 9, wherein said hydrophobic monomer contains at least an acrylate compound represented by the following structural formula (1):
CH₂═CH—COOCₙH₍₂ₙ₊₁₎ (n is 3 to 10) (1).

13. A process for producing the dispersible coloranting material according to claim 1, which comprises the step of subjecting a radical-polymerizable monomer to aqueous precipitation polymerization in an aqueous dispersion of water-insoluble colorant particles in the presence of a cationic or amphoteric water-soluble radical-polymerization initiator to fuse the colorant particles and the flat chargeable resin pseudo fine particles together.

14. A water-based ink in which the dispersible colorant according to claim 1 is contained.

15. The water-based ink according to claim 14, which is used for ink-jet recording.

16. An ink tank in which the water-based ink according to claim 14 is held.

17. An ink-jet recording apparatus in which the water-based ink according to claim 15 is used to form an ink-jet recorded image.

18. An ink-jet recording process in which the water-based ink according to claim 15 is used to form an image by means of an ink-jet recording apparatus.

19. An ink-jet recorded image formed using the water-based ink according to claim 15 by means of an ink-jet recording apparatus.
